(19) United States
(12) Patent Application Publication
(10) Pub. No.: US 2022/0274040 A1
(43) Pub. Date: Sep. 1, 2022

(54) REMOVAL OF VOCS AND FINE PARTICULATE MATTER BY METAL ORGANIC FRAMEWORKS COATED ELECTRET MEDIA (E-MOFILTER)

(71) Applicant: VIRGINIA COMMONWEALTH UNIVERSITY INTELLECTUAL PROPERTY FOUNDATION, Richmond, VA (US)

(72) Inventors: Sheng-Chieh CHEN, Glen Allen, VA (US); Weining WANG, Glen Allen, VA (US); Xiang HE, Richmond, VA (US); Yu ZHANG, Richmond, VA (US)

(21) Appl. No.: 17/774,389

(22) PCT Filed: Nov. 6, 2020
(86) PCT No.: PCT/US2020/059322

§ 371 Date: May 4, 2022

Related U.S. Application Data
(60) Provisional application No. 62/932,573, filed on Nov. 8, 2019.

(51) Int. Cl. B01D 46/00; B01D 39/16; B01D 53/02; B01J 20/22; B01J 20/26; B01J 20/28; B01J 20/32

(52) U.S. Cl. CPC B01D 46/0036; B01D 46/0032; B01D 39/1623; B01D 53/02; B01D 46/0001; B01J 20/226; B01J 20/26; B01J 20/28028; B01J 20/28061; B01J 20/28064; B01J 20/28071; B01J 20/2808; B01J 20/28004; B01J 20/3208; B01J 20/3214; B01J 20/3272; B01J 20/3293; B01D 2239/0407; B01D 2239/0435; B01D 2239/0492; B01D 2239/0618; B01D 2239/1233; B01D 2253/204; B01D 2253/306; B01D 2253/311; B01D 2253/308; B01D 2253/304; B01D 2257/708

(57) ABSTRACT

Provided herein are electret-MOF filter embedded with particles derived from metal-organic frameworks (MOF) and their methods of manufacturing. The methods of manufacturing the electret-MOF filter can include suspending MOF particles in a solvent to form a MOF particle mixture, contacting a charged polymeric fibrous web with the MOF particle mixture, and coating the charged polymeric fibrous web with the MOF particles by flowing the MOF particle mixture through an inverse side of the polymeric fibrous web. The disclosed coating method can deposit MOF particles uniformly, without formation of films at interstitial spaces between fibers. The electret-MOF filter can simultaneously remove fine particulate matters (PMs) and hazardous gaseous pollutants (including volatile organic compounds (VOCs)) with high particle holding and gas adsorption capacities, and with very low air resistance.

### CROSS-REFERENCE TO RELATED APPLICATIONS

This application claims the benefit of U.S. Provisional Application No. 62/932,573 filed Nov. 8, 2019 which is hereby incorporated by reference in its entirety.

### FIELD

This disclosure relates generally to electret filter media particularly to filter media containing metal organic framework particles.

### BACKGROUND

Statistical data show that people spend about 87-90% of their time indoors. Accordingly, indoor air quality (IAQ) is a major concern not only in developing countries but also developed countries. In developing counties, commercial buildings and apartments are being built and homes are being refurnished due to improved wealth. That increases the use of a large quantity of furnishings, glues, paints, etc., leading to the increase in the emissions of volatile organic compounds (VOCs). Besides, due to the high concentration of ambient fine particulate matters (PM_{2.5}, particulate matter with an aerodynamic diameter less than 2.5 μm), PM_{2.5} can infiltrate into indoor environments. In developed countries, indoor concentrations of some pollutants are found to be often 2-5 times higher than typical outdoor concentrations. This is mainly due to the design of lower air exchange rates for energy-efficient building construction and an increased use of for example, synthetic building materials, furnishings, and personal care products. Researches have shown that VOCs and PM_{2.5} can lead to acute and chronic effects on human respiratory and central nervous systems and eventually cause hematological problems and cancer.

To mitigate PM_{2.5} for healthy indoor environments, air filters are utilized in the heating, ventilating, air conditioning (HVAC) system, and indoor air cleaners (IACs). Electret filters, with quasi-permanent electrical charges on the fibers, acquiring an additional force of electrostatic attraction, show a high initial filtration efficiency and a much lower pressure drop (ΔP) compared to mechanical filters. They have been widely used to improve the quality of indoor air in recent years. However, to achieve a good IAQ, not only PM_{2.5} but also VOC such as formaldehyde and BTXs (benzene, toluene, xylene), should be mitigated. Traditionally, simultaneous removal of PM and VOC pollutions is achieved by combining granular activated carbon (GAC) or other adsorbents, such as zeolites, with filter media, either embedded in or separately as an individual filtration module. Both assembly strategies make the filtration module bulky and heavy. There is also an advanced high-end photocatalytic oxidation (PCO) technology applied in IACs. However, the high price and requirement of UV light source cause them to be inconvenient. The activated carbon fiber (ACF) filters were developed to simultaneously remove PMs and VOCs. However, the ACF is not dielectric and cannot be charged, making them less efficient for PM removal compared with electret media at the same mechanical properties (fiber diameter, porosity, and thickness).

There is a need for securing the air quality for different indoor environments, including residential houses and apartments, commercial buildings, hospital buildings, school buildings, pharmaceutical manufacturing cleanrooms, semiconductor manufacturing cleanrooms, and the like. The compositions, devices, and methods disclosed herein address these and other needs.

### SUMMARY

Provided herein are electret filter media embedded with particles derived from metal-organic frameworks (MOFs) having a high surface area (also referred to herein as E-MOFilter). Methods of preparing the electret-MOF filter, which methods allow the filter to exhibit several advantageous properties are also disclosed. The electret-MOF filter can simultaneously remove fine particulate matters (PMs) and hazardous gaseous pollutants (including volatile organic compounds (VOCs)) with high particle holding and gas adsorption capacities, and with very low air resistance.

The methods of manufacturing the electret-MOF filter can include suspending MOF particles in a solvent, preferably water, at a concentration of 1.0 wt % or less to form a MOF particle mixture, contacting a charged polymeric fibrous web with the MOF particle mixture, and coating the charged polymeric fibrous web with the MOF particles by flowing the MOF particle mixture through an inverse side of the polymeric fibrous web at a flow rate of at least 10 mL·min⁻¹. In the exemplified methods of making the electret-MOF filter, MOF powders were mixed into a liquid to form a liquid suspension. A liquid filtration apparatus was used to load the MOF particles onto the fibers of the fibrous electret web. The results showed that the current coating method can deposit MOF particles uniformly on individual fiber as well as in depth of the electret media, without clogging and formation of films at interstitial spaces between fibers.

In some aspects, the electret-MOF filter comprises a charged polymeric fibrous web and a population of MOF particles uniformly dispersed throughout the charged polymeric fibrous web, wherein the MOF particles comprise pores and have a pore volume of at least 0.3 cm³/g, a surface area of at least 500 m² g⁻¹, or a combination thereof are disclosed.

The metal ion present in the MOF particles can be selected from Mg, Ca, Sr, Ba, Sc, Ti, Zr, Cr, Mo, Mn, Fe, Co, Ni, Pd, Pt, Cu, Zn, Al, Ga, In, Sn, Bi, Cd, Mn, Gd, Ce, or Cr, preferably a transition metal selected from Sc, Ti, V, Cr, Mn, Fe, Co, Ni, Cu, Zn, Al, Zr, Y, Zr, and Mo, more preferably a Period 4, Groups 3-12 metal such as Zn, Fe, Cu, Co, Ni, Ti, Al, Zr, Y, Zr, or Mo. The organic portion of the MOF particles can be derived from an aromatic carboxylate ligand (e.g., imidazole-based ligands, or benzyl or naphthyl carboxylate based ligand). The MOF particles can be chemically or physically functionalized for purposes including tuning their binding selectivity, improving coating uniformity, reduce relative humidity (RH) effects on toluene efficiency reduction, or a combination thereof. In some embodiments, the MOF particles can be stable in hydrophilic or hydrophobic environments or can be tuned to exhibit these properties. For example, the MOF particles can be chemically functionalized to facilitate stability in hydrophobic environments, improve coating uniformity, and reduce relative humidity (RH) effects on toluene efficiency reduction, or a combination thereof by functionalizing with polydimethylsiloxane (PDMS). In some cases, the polymeric fibers can also be chemically functionalized to facilitate stability in hydrophobic environments, improve coating uniformity, and reduce relative humidity (RH) effects on toluene efficiency reduction, or a combination thereof.

As described herein, the MOF particles used in the electret-MOF filter are porous and can be microporous (exhibiting a type I adsorption isotherms at 77 K with no hysteresis), mesoporous, or a combination thereof. In some cases, the MOF particles are microporous and have an average pore size of 2 nm or less (e.g., from 0.2 nm to 2 nm or from 0.2 nm to 1.5 nm). The MOF particles also exhibit a high average surface area such as 500 m²g⁻¹ or greater (e.g., 800 m²g⁻¹ or greater, 1,200 m²g⁻¹ or greater, 2,500 m²g⁻¹ or greater, from 500 m²g⁻¹ to 14,000 m²g⁻¹, or from 800 m²g⁻¹ to 5,000 m²g⁻¹), as determined using multiple layer BET method. The MOF particles can have an average particle size, wherein their longest dimension is 3 microns or less (e.g., 1 micron or less, from 0.1 micron to 1.5 microns, or from 0.5 microns to 3 microns). The ratio of pore size of the electret-MOF filter to the average particle size diameter of the MOF particles can be 50 or less (e.g., 30 or less, 15 or less, or from 3 to 15). Some examples of MOF particles suitable for use in the electret-MOF filter include MIL-125-NH₂, UiO-66-NH₂, ZIF-67, or a combination thereof. The electret-MOF filter can comprise the MOF particles in an amount of up to 30% by weight of the electret-MOF filter (e.g., from 3% to 30% or from 10% to 20% by weight).

As disclosed herein, the electret-MOF filter are also derived from a charged polymeric fibrous web. The charged polymeric fibrous web can be woven or non-woven, preferably the polymeric fibrous web is a non-woven microfiber web. The fibers in the web can have an average fiber diameter of 100 microns or less (e.g., 20 microns or less, from 0.3 microns to 20 microns, from 10 microns to 100 microns, or from 5 microns to 20 microns). In some instances, the fiber diameter of the polymeric web is polydisperse. For example, a polymeric fibrous web having an average fiber diameter of 10 microns can comprise fibers ranging in diameter from 5-20 microns. In other examples, the standard deviation of the fiber diameter can be relatively small (such as 5 microns or less, 4 microns or less, 3 microns or less, or 2 microns or less). In these examples, a polymeric fibrous web having an average fiber diameter of 10 microns can range in fiber diameter from 8-12 microns.

The electret-MOF filter can comprise a plurality of fibers. For example, the electret filter can include 2 or more layers of polymeric fibrous webs, each web having a different average fiber diameter. Electret-MOF filter comprising a plurality of fibers have been shown in some cases to exhibit higher particle loading (holding) capacity. When more than one polymeric fibrous web layers are present, the polymeric web layer with larger fiber diameter can be placed in the front and the fine fiber layer can be in the back. For example, the electret-MOF filter can comprise a first layer including charged polymeric webs, wherein the fibers in the first layer fibers have an average fiber diameter of 10 microns or greater (for e.g., 15 um or greater, or 30 um or greater, or 50 um or greater, from 50 microns to 120 microns, from 70 microns to 90 microns); and a second layer including a charged polymeric fibrous web, wherein the fibers in the second layer have an average fiber diameter of 20 microns or less (for e.g., 15 microns or less, or 5 microns or less, 1 micron or less, from 0.5 microns to 20 microns, from 7 microns to 15 microns). Each layer of polymeric fibrous web can have an average thickness of 2 mm or less (e.g., from 0.15 mm to 2 mm, from 0.2 mm to 1.5 mm, or from 0.3 mm to 1 mm). The average total thickness of the polymeric fibrous web can be 2 mm or less (e.g., from 0.15 mm to 2 mm, from 0.2 mm to 1.5 mm, or from 0.3 mm to 1 mm). The basis weight of the polymeric fibrous web can be 150 g/m² or less (e.g., 120 g/m² or less, or from 10 g/m² to 120 g/m²). The fibrous web can include the base media to form commercial pleated HVAC and HEPA filters.

As described herein, the electret-MOF filter can simultaneously remove fine particulate matters (PMs) and hazardous gaseous pollutants with high particle holding and gas adsorption capacities, and with very low air resistance. In some embodiments, the electret-MOF filter exhibit a volatile organic compound (VOC) load reduction of at least 75% (at least 80%, at least 85%, or at least 90%), when tested at a VOC concentration of 5 ppm with 5 cm s⁻¹ face velocity. In some embodiments, the electret-MOF filter exhibit a PM_{2.5} load reduction of at least 80% in mass, when tested under 5 cm s⁻¹ face velocity. The air resistance of the electret-MOF filter can be such that the filter media only exhibit a pressure drop of less than 50 Pa (less than 35 Pa, less than 25 Pa, or less than 15 Pa), tested at 5 cm/s (Pa). The electret-MOF filter may also exhibit a charge retention of at least 95%, tested using a water soaking-drying tests.

In the exemplified embodiments, two fibrous electret webs with different minimum efficiency reporting value (MERV), used as the base substrates, were embedded with three different MOF particles (ZIF 67, MIL-125, or UiO-66), all of which demonstrated ability to simultaneously remove fine PMs and hazardous gaseous pollutants. In the aspect of PM filtration, the size fractional efficiency was comparable with the clean fibrous electret web, indicating there was a negligible charge degradation because of the MOF particle coating and deposition process. The pressure drop due to MOF particle depositions was also reasonably comparable to the original fibrous electret web. The electret-MOF filter also demonstrated high toluene removal efficiency. PM aging tests were conducted and results showed that the PM holding capacity was comparable (with only minor impairment) with clean fibrous electret webs.

The electret-MOF filter can be incorporated into several devices including, but not limited to, a respirator filter, a room or building ventilation system filter, a vehicle, train, bus and airplane ventilation system filter, an air conditioner filter, a furnace filter, a room air purifier filter, a vacuum cleaner filter, or a computer disk drive filter.

Methods of using the electret-MOF filter are also provided herein. The filter media can be used for simultaneously adsorbing particulate and volatile organic compounds in a gaseous environment, such as air, wherein the method can include contacting the environment with an electret-MOF filter as described herein. In the processes described herein, the volatile organic compounds can be present at a concentration in the range of 0.01 ppm to 50 ppm, and may be selected from acetic acid, acetaldehyde, formaldehyde, toluene, or a combination thereof.

Various aspects and features of embodiments of the present disclosure will become further apparent to those skilled in the art upon reviewing the following detailed description and the examples, which are integral to the present application.

### BRIEF DESCRIPTION OF THE DRAWINGS

FIG. 1 shows an experimental setup to coat MOF particles onto charged filter webs. FIG. 2 shows an experiment setup for testing whether the E-MOFilter is able to simultaneously remove PM_{2.5} and toluene.

FIG. 3 shows an experimental setup for the initial removal efficiency and adsorption capacity of toluene by the E-MOFilters.

FIG. 4 is a calibration curve, from 0.05 to 50 ppm, for the toluene by GC-FID.

FIGS. 5A-5D show SEM image of MIL-125-NH₂ (FIG. 5A), FT-IR spectrum of the MIL-125-NH₂ (FIG. 5B), XRD patterns of MIL-125-NH₂ (FIG. 5C), and BET analysis of pore diameter distribution of MIL-125-NH₂ (FIG. 5D).

FIG. 6 shows characterization results of ZIF-67 and UiO-66-NH₂ particles for SEM, FT-IR and XRD analysis.

FIGS. 7A-7C show BET analysis for the pore size distributions of MIL-125-NH₂ coated HEPA E-MOFilter (FIG. 7A) and MERV 13 E-MOFilter (FIG. 7B), and SEM images of MIL-125-NH₂ depositions on two E-MOFilters (FIG. 7C).

FIG. 8 shows BET analysis for the pore size distributions of ZIF-67 and UiO-66-NH₂ coated HEPA E-MOFilters (25 wt %) and that of activated carbon fibers (ACFs).

FIGS. 9A-9B show comparison of FT-IR spectrum (FIG. 9A) and XRD patterns (FIG. 9B) amongst original MERV 13 filter, MIL-125-NH₂ particles and MIL-125-NH₂ based

E-MOFilter. As can be seen the E-MOFilter remains both functional groups and crystal structure of MERV 13 media (polypropylene) and MOF particles, exactly a superposition from the two materials. It is concluded that the coating of MOFs onto the electret media by liquid filtration method was a physical phenomenon, i.e. no interaction caused between MOFs and electret media.

FIG. 10 shows initial size-fractioned efficiency of MERV 13 E-MOFilter coated with different levels of MIL-125-NH₂ particles.

FIG. 11 shows initial size-fractioned efficiency of HEPA E-MOFilter coated with high level of MIL-125-NH₂ particles.

FIG. 12 shows the effects of the MOF loading on the evolution of pressure drop of the MERV 13 E-MOFilters during filtration.

FIGS. 13A-13D show dynamic size-fractioned efficiency of original (FIG. 13A), low coating (FIG. 13B), medium coating (FIG. 13C), and high coating (FIG. 13D) MERV 13 filters along PM aging process.

FIGS. 14A-14B show comparison of initial toluene removal efficiency between HEPA and MERV 13 based E-MOFilters coated with different MOF particles—25 wt % high level (FIG. 14A) and comparison of initial toluene removal efficiency by 1 and 2 layers of MERV 13 filter coated with different levels of MIL-125-NH₂ particles (FIG. 14B).

FIG. 15 shows comparison of breakthrough curve amongst ACFs and MERV 13 based E-MOFilters coated with different levels of MIL-125-NH₂ particles.

### DESCRIPTION

Before the present articles and methods are disclosed and described, it is to be understood that the aspects described below are not limited to specific near infrared agents, fluorescent proteins, or means of affixing the fluorophore to the surgical article, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a MOF particle” includes mixtures of two or more such particles, reference to “the polymeric filter web” includes two or more of such webs, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

The term “microfibers” refers to fibers having a median diameter of at least one micrometer.

The term “nonwoven web” refers to a fibrous web characterized by entanglement or point bonding of the fibers.

The terms “particle” and “particulate” are used substantially interchangeably. Generally, a particle or particulate means a small distinct piece or individual part of a material in finely divided form. However, a particulate may also include a collection of individual particles associated or clustered together in finely divided form. Thus, individual particles used in certain exemplary embodiments of the present disclosure may clump, physically intermesh, electrostatically associate, or otherwise associate to form particulates. In certain instances, particulates in the form of agglomerates of individual particles may be intentionally formed.

The term “porosity” refers to a measure of void spaces in a material. Size, frequency, number, and/or interconnectivity of pores and voids contribute the porosity of a material.

The term “layer” refers to a single stratum formed between two major surfaces. A layer may exist internally within a single web, e.g., a single stratum formed with multiple strata in a single web have first and second major surfaces defining the thickness of the web. A layer may also exist in a composite article comprising multiple webs, e.g., a single stratum in a first web having first and second major surfaces defining the thickness of the web, when that web is overlaid or underlaid by a second web having first and second major surfaces defining the thickness of the second web, in which case each of the first and second webs forms at least one layer. In addition, layers may simultaneously exist within a single web and between that web and one or more other webs, each web forming a layer.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

A weight percent (wt. %) of a component, unless specifically stated to the contrary, is based on the total weight of the formulation or composition in which the component is included.

Reference will now be made in detail to specific aspects of the disclosed materials, compounds, compositions, articles, and methods, examples of which are illustrated in the accompanying Examples.

Electret-MOF Filter

Electret filters have been used to improve the quality of indoor air. The term “electret” as used herein refers to a dielectric material with the presence of quasi-permanent real charges on the surface or in the bulk of the material. An electret behaves like a battery or acts as an electrical counterpart of a permanent magnet. Traditionally, however, simultaneous removal of particulate material (PM) and volatile organic compound (VOC) pollutions is achieved by combining granular activated carbon (GAC) or other adsorbents, e.g., zeolites, with filter media, either embedded in or separately as an individual filtration module. Both assembly strategies make the filtration module bulky and heavy. Disclosed herein are electret-MOF filter (also referred to herein as E-MOFilter) comprising a charged polymeric fibrous web (preferably an electret polymeric fibrous web) embedded with a population of metal-organic framework (MOF) particles. The disclosed electret-MOF filter can simultaneously remove fine particulate matter (PMs) and hazardous gaseous pollutants (including volatile organic compounds (VOCs)) with high particle holding and gas adsorption capacities, and with very low air resistance.

In general, there are many ways to incorporate particles with the filter media. For example, particles can be incorporated into the filter media by in situ interweaving, electrospinning (physical blending of particles with polymers), freeze-drying, hot-pressing, roll-to-roll processing, air filtration deposition, etc. However, to choose an appropriate method for the current disclosure, the following considerations were taken into account in the process of combining the MOF particles with the charged fibers. Firstly, the charges of the electret media should not be degraded; secondly, the MOF particles should firmly attach to the electret media with a minimized growth of air resistance; thirdly, the transfer process is simple and cost-efficient. The known methods for generating particulate loaded nonwoven would not meet these considerations. For example, the interweaving could not tightly hold the MOF particles and particle shedding during filtration may occur; both freeze-drying and hot pressing would experience harsh temperature or pressure changes, therefore, the degradation for fiber charges is unavoidable; the roll-to-roll can also cause shedding issue; and the air filtration always leads to a non-uniform deposition of particles in depth of the media.

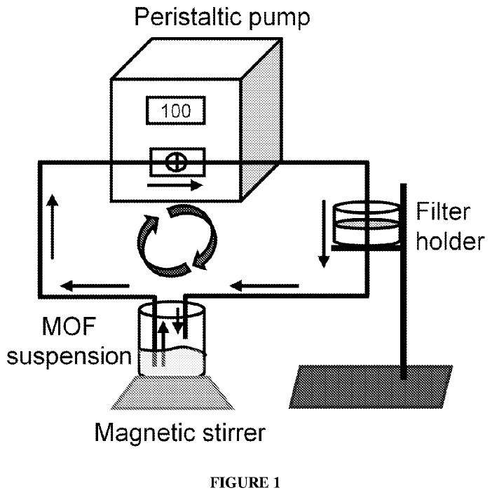

As none of the existing methods were appropriate for preparing electret filter media having MOF particles uniformly distributed throughout the polymeric fibrous web, disclosed herein is a liquid filtration (coating) method to fabricate the E-MOFilters. The choice of liquid filtration is to utilize the inherent more uniform particle deposition in liquid filtration process especially in the case of pore to particle diameter ratio is not low, e.g., 5-20. The inventors have also found that there was a negligible charge degradation in water soaking-drying tests for electret filter media. If the MOF particles can be uniformly coated onto the fibers and in depth of the media without the formation of particle cake, the applied quantity of MOF particles and the increase of air resistance can be minimized (lower than dendrite structure in air filtration), therefore, the shielding of charge by the MOF particles should be minimized Besides, the VOC removal efficiency should be maximized due to the high surface area of MOF particles. The method for preparing the electret-MOF filter disclosed herein includes suspending MOF particles in a solvent, preferably water. The MOF particles can be suspended at a concentration of 1.0 wt % or less (such as 0.8 wt % or less, 0.5 wt % or less, 0.2 wt % or less, or 0.1 wt % or less) to form a MOF particle mixture. The method can further include contacting a polymeric fibrous web with the MOF particle mixture, and coating the polymeric fibrous web with the MOF particles by flowing the MOF particle mixture through an inverse side of the polymeric fibrous web at a flow rate of at least 10 mL·min⁻¹. In some instances, the flow rate is at least 20 mL·min⁻¹, at least 30 mL·min⁻¹, at least 50 mL·min⁻¹, at least 60 mL·min⁻¹, at least 80 mL·min⁻¹, or at least 100 mL·min^{-I}). The coating flow (or filtration direction) was introduced from the back side of the filter to reduce the deposition quantity of MOF particles on the first few layers of the E-MOFilters. Coating can be controlled using a peristaltic pump. The method provides charge shielding and reduction in void space by MOF particles. FIG. 1 shows the experimental setup for the MOF coating. The MOF particles are uniformly distributed throughout the polymeric fibrous web, which fibrous web may form a three-dimensional network around the particles.

For the electret-MOF filter disclosed herein, the filter can have a basis weight, which may be varied depending upon the particular end use of the electret-MOF filter. In some instances, the electret-MOF filter can have a basis weight of less than about 1000 g/m². In some embodiments, the electret-MOF filter has a basis weight of from about 50 g/m² to about 500 g/m². In other embodiments, the electret-MOF filter has a basis weight of from about 10 g/m² to about 300 g/m².

As with the basis weight, the electret-MOF filter will exhibit a thickness, which may be varied depending upon the particular end use of the media. Typically, the electret-MOF filter can have a thickness of less than about 50 millimeters (mm). In some embodiments, the electret-MOF filter has a thickness of from about 0.1 mm to about 10 mm. In other embodiments, the electret-MOF filter has a thickness of from about 0.3 mm to about 50 mm.

In other embodiments, the electret-MOF filter may have a pore size and exhibit a ratio of pore size of the electret filter to the diameter of the MOF particles of 50 or less (e.g., 30 or less, 25 or less, 20 or less, 15 or less, 10 or less, 5 or less, 5 or greater, 10 or greater, 15 or greater, 20 or greater, 25 or greater, from 3 to 50, from 3 to 30, from 3 to 20, from 3 to 15, from 5 to 30, from 5 to 20, from 5 to 15, or from 5 to 10).

As described herein, the electret-MOF filter can simultaneously remove fine particulate matter (PMs) and hazardous gaseous pollutants with high particle holding and gas adsorption capacities, and with very low air resistance. In some embodiments, the electret-MOF filter exhibit a volatile organic compound (VOC) load reduction of at least 75% (at least 80%, at least 85%, at least 90%, at least 95%, or at least 99%), when tested at a VOC concentration of 5 ppm with 5 cm s⁻¹ face velocity. In some embodiments, the electret-MOF filter exhibit a PM_{2.5} load reduction of at least 80% in mass (at least 85%, at least 90%, at least 92%, at least 95%, or at least 99%), when tested under 5 cm s⁻¹ face velocity. The air resistance of the electret-MOF filter can be such that the filter media only exhibit a pressure drop of less than 50 Pa (or less than 45 Pa, less than 40 Pa, less than 35 Pa, less than 30 Pa, less than 25 Pa, less than 20 Pa, or less than 15 Pa), tested at 5 cm/s (Pa). The electret-MOF filter can also exhibit a charge retention of at least 95% (at least 96%, at least 97%, or at least 99%), tested using a water soaking-drying tests.

Fiber Material

The electret-MOF filter include a polymeric fibrous web which can be woven or non-woven. Preferably, the polymeric fibrous web is a non-woven fibrous web. As noted above, the nonwoven fibrous web may form a three-dimensional network around the MOF particles. The fiber population may comprise sub-micrometer fibers, microfibers, ultrafine microfibers, or a combination thereof. The sub-micrometer fiber components comprise fibers having a median fiber diameter ranging from about 0.2 μm to about 0.9 μm, such as from about 0.5 μm to about 0.7 μm. The microfiber component can comprise fibers having a median fiber diameter of at least 1 μm. In some exemplary embodiments, the microfiber component comprises fibers having a median fiber diameter ranging from about 2 μm to about 100 μm. In other exemplary embodiments, the microfiber component comprises fibers have a median fiber diameter ranging from about 5 μm to about 50 μm. The ultrafine fiber components comprise fibers having a median fiber diameter of less than about 0.2 μm. Sub-micrometer fibers and ultrafine microfibers, which are by their very nature weak, but may provide very high specific surface areas that are a benefit for certain applications. The diameter of the fibers in a given fiber component can be determined by a scanning or transmission electron microscope (SEM/TEM) or theoretical filtration model.

As described herein, the fiber diameter of the polymeric web is polydisperse. Preferably, the fibers used in the presently disclosed electret-MOF filter are microfibers, that is, the polymeric fibrous web is a microfiber web or a combination of a sub-micron and microfiber web. The fibers in the polymeric fibrous web can have an average fiber diameter of 100 microns or less (e.g., 90 microns or less, 80 microns or less, 70 microns or less, 60 microns or less, 50 microns or less, 40 microns or less, 30 microns or less, 25 microns or less, 20 microns or less, 18 microns or less, 15 microns or less, 12 microns or less, 10 microns or less, 9 microns or less, 8 microns or less, 7 microns or less, 6 microns or less, 5 microns or less, 4 microns or less, 3 microns or less, or 2 microns or less). The fibers in the polymeric fibrous web can have an average fiber diameter of 0.1 micron or greater (e.g., 0.2 microns or greater, 0.3 microns or greater, 0.4 microns or greater, 0.5 microns or greater, 0.8 microns or greater, 1 microns or greater, 1.5 microns or greater, 2 microns or greater, 3 microns or greater, 4 microns or greater, 5 microns or greater, 6 microns or greater, 8 microns or greater, 10 microns or greater, 12 microns or greater, 15 microns or greater, 20 microns or greater, 25 microns or greater, 30 microns or greater, 35 microns or greater, 40 microns or greater, 50 microns or greater, 75 microns or greater, 80 microns or greater, or up to 100 microns). The fibers in the polymeric fibrous web can have an average fiber diameter of from 0.1 micron to 100 microns (e.g., from 0.3 microns to 100 microns, from 10 microns to 100 microns, from 10 microns to 50 microns, from 5 microns to 100 microns, from 5 microns to 50 microns, from 5 microns to 20 microns, from 0.3 microns to 20 microns, or from 1 micron to 20 microns). The standard deviation of the average fiber diameter can be (such as 20 microns or less, 18 microns or less, 15 microns or less, 12 microns or less, 10 microns or less, 8 microns or less, 6 microns or less, 5 microns or less, 4 microns or less, 3 microns or less, or 2 microns or less.

In some examples, the polymeric fibrous web comprises a plurality of fibers, such as a first fiber having an average fiber diameter of 20 microns or less (for e.g., from 0.5 microns to 20 microns, from 1 micron to 20 microns, from 5 microns to 20 microns, from 5 microns to 15 microns, or from 7 microns to 15 microns) and a second fiber having an average fiber diameter of 50 microns or greater (for e.g., from 50 microns to 120 microns, from 50 microns to 100 microns, or from 70 microns to 90 microns).

In further instances, the web can comprise a plurality of fibers, wherein the electret-MOF filter can include 2 or more layers of polymeric fibrous webs, each web having a different average fiber diameter. For example, the electret-MOF filter can comprise a first layer including a polymeric web, wherein the fibers have an average fiber diameter of 10 microns or greater (for e.g., 15 microns or greater, 30 microns or greater, 50 microns or greater, from 10 microns to 120 microns, or from 50 microns to 90 microns); and a second layer including a polymeric fibrous web, wherein the fibers have an average fiber diameter of 20 microns or less (for e.g., 15 microns or less, 5 microns or less, 1 micron or less, from 0.5 microns to 20 microns, or from 2 microns to 15 microns).

The polymeric fibrous web can include one or more layers. Each layer of web can have an average thickness of 100 mm or less (e.g., 75 mm or less, 50 mm or less, 40 mm or less, 30 mm or less, 25 mm or less, 20 mm or less, 15 mm or less, 10 mm or less, 9 mm or less, 8 mm or less, 7 mm or less, 5 mm or less, 4 mm or less, 3 mm or less, 2 mm or less, 1.9 mm or less, 1.8 mm or less, 1.7 mm or less, 1.6 mm or less, 1.5 mm or less, 1.3 mm or less, 1.2 mm or less, 1.0 mm or less, 0.9 mm or less, 0.8 mm or less, 0.7 mm or less, 0.6 mm or less, 0.5 mm or less, 0.4 mm or less, or 0.3 mm or less). The layer of polymeric fibrous web can have an average thickness of 0.1 mm or greater (e.g., 0.2 mm or greater, 0.3 mm or greater, 0.4 mm or greater, 0.5 mm or greater, 0.6 mm or greater, 0.7 mm or greater, 1 mm or greater, 1.5 mm or greater, 1.8 mm or greater, 2 mm or greater, 2.2 mm or greater, 2.5 mm or greater, 3 mm or greater, 5 mm or greater, 8 mm or greater, 10 mm or greater, 12 mm or greater, 15 mm or greater, 18 mm or greater, 20 mm or greater, 25 mm or greater, or 30 mm or greater). Each polymeric fibrous web can have an average layer thickness from 0.1 mm to 100 mm (e.g., from 0.1 mm to 50 mm, from 0.1 mm to 20 mm, from 0.1 mm to 5 mm, from 0.1 mm to 2 mm, from 0.1 mm to 1 5 mm, from 0.1 mm to 1 mm, from 0.2 mm to 20 mm, from 0.2 mm to 10 mm, from 0.2 mm to 5 mm, from 0.2 mm to 2 mm, from 0.2 mm to 1.5 mm, from 0.2 mm to 1 mm, from 0.3 mm to 5 mm, from 0.3 mm to 10 mm, from 0.3 mm to 3 mm, from 0.3 mm to 2 mm, from 0.3 mm to 1 5 mm, from 0.15 mm to 2 mm, or from 0.3 mm to 1 mm).

The polymeric fibrous web can have an overall (total) average thickness of 100 mm or less (e.g., 75 mm or less, 50 mm or less, 40 mm or less, 30 mm or less, 25 mm or less, 20 mm or less, 15 mm or less, 10 mm or less, 9 mm or less, 8 mm or less, 7 mm or less, 5 mm or less, 4 mm or less, 3 mm or less, 2 mm or less, 1.9 mm or less, 1.8 mm or less, 1.7 mm or less, 1.6 mm or less, 1.5 mm or less, 1.3 mm or less, 1.2 mm or less, 1.0 mm or less, 0.9 mm or less, 0.8 mm or less, 0.7 mm or less, 0.6 mm or less, 0.5 mm or less, 0.4 mm or less, or 0.3 mm or less). The layer(s) of polymeric fibrous web can have a total average thickness of 0.1 mm or greater (e.g., 0.2 mm or greater, 0.3 mm or greater, 0.4 mm or greater, 0.5 mm or greater, 0.6 mm or greater, 0.7 mm or greater, 1 mm or greater, 1.5 mm or greater, 1.8 mm or greater, 2 mm or greater, 2.2 mm or greater,2.5 mm or greater, 3 mm or greater, 5 mm or greater, 8 mm or greater, 10 mm or greater, 12 mm or greater, 15 mm or greater, 18 mm or greater, 20 mm or greater, 25 mm or greater, or 30 mm or greater). The total thickness of the polymeric fibrous web can be from 0.1 mm to 100 mm (e.g., from 0.1 mm to 50 mm, from 0.1 mm to 20 mm, from 0.1 mm to 5 mm, from 0.1 mm to 2 mm, from 0.1 mm to 1.5 mm, from 0.1 mm to 1 mm, from 0.2 mm to 20 mm, from 0.2 mm to 10 mm, from 0.2 mm to 5 mm, from 0.2 mm to 2 mm, from 0.2 mm to 1 5 mm, from 0.2 mm to 1 mm, from 0.3 mm to 5 mm, from 0.3 mm to 10 mm, from 0.3 mm to 3 mm, from 0.3 mm to 2 mm, from 0.3 mm to 1.5 mm, from 0.15 mm to 2 mm, or from 0.3 mm to 1 mm).

The polymeric fibrous web can have a basis weight of 150 g/m² or less (e.g., 140 g/m² or less, 130 g/m² or less, 120 g/m² or less, 110 g/m² or less, 100 g/m² or less, 90 g/m² or less, 80 g/m² or less, 75 g/m² or less, 70 g/m² or less, 65 g/m² or less, 60 g/m² or less, 50 g/m² or less, 40 g/m² or less, 30 g/m² or less, 20 g/m² or less, or 10 g/m² or less). The basis weight of the polymeric fibrous web can be 10 g/m² or greater (e.g., 15 g/m² or greater, 20 g/m² or greater, 25 g/m² or greater, 30 g/m² or greater, 40 g/m² or greater, 45 g/m² or greater, 50 g/m² or greater,55 g/m² or greater, 60 g/m² or greater, 65 g/m² or greater, 70 g/m² or greater, 75 g/m² or greater, 80 g/m² or greater, 85 g/m² or greater, 90 g/m² or greater, 95 g/m² or greater, 100 g/m² or greater, or 110 g/m² or greater). The basis weight of the polymeric fibrous web can be from 10 g/m² to 150 g/m² (e.g., from 20 g/m² to 150 g/m², from 35 g/m² to 150 g/m², from 55 g/m² to 150 g/m², from 60 g/m² to 150 g/m², from 65 g/m²to 150 g/m², from 70 g/m² to 150 g/m², from 20 g/m² to 130 g/m², from 50 g/m² to 130 g/m², from 60 g/m² to 130 g/m², from 70 g/m² to 130 g/m², from 20 g/m² to 120 g/m², from 50 g/m² to 120 g/m², from 60 g/m² to 120 g/m², from 70 g/m² to 120 g/m², from 10 g/m² to 100 g/m², from 20 g/m² to 100 g/m², from 50 g/m² to 100 g/m², from 60 g/m² to 100 g/m², or from 70 g/m² to 100 g/m²).

In some embodiments, the fiber component may comprise one or more polymeric materials. Suitable polymeric materials include, but are not limited to, polyolefins such as polypropylene and polyethylene; polyesters such as polyethylene terephthalate and polybutylene terephthalate; polyamide (Nylon-6 and Nylon-6,6); polyurethanes; polybutene; polylactic acids; polyvinyl alcohol; polyphenylene sulfide; polysulfone; liquid crystalline polymers; polyethylene-co-vinylacet ate; polyacrylonitrile; cyclic polyolefins; polyoxymethylene; polyolefinic thermoplastic elastomers; or a combination thereof. Webs have also been prepared from amorphous polymers such as polystyrene. The specific polymers listed here are examples only, and a wide variety of other polymeric or fiber-forming materials are useful.

A variety of synthetic fiber-forming polymeric materials may be employed, including thermoplastics and especially extensible thermoplastics such as linear low density polyethylenes (e.g., those available under the trade designation DOWLEX™ from Dow Chemical Company, Midland, Mich.), thermoplastic polyolefinic elastomers (TPE's, e.g., those available under the trade designations ENGAGE™ from Dow Chemical Company, Midland, Mich.; and VISTAMAXX™ from Exxon-Mobil Chemical Company, Houston, Tex.), ethylene alpha-olefin copolymers (e.g., the ethylene butene, ethylene hexene or ethylene octene copolymers available under the trade designations EXACT™ from Exxon-Mobil Chemical Company, Houston, Tex.; and ENGAGE™ from Dow Chemical Company, Midland, Mich.), ethylene vinyl acetate polymers (e.g., those available under the trade designations ELVAX™ from E.I. DuPont de Nemours & Co., Wilmington, Del.), polybutylene elastomers (e.g., those available under the trade designations CRASTIN™ from E.I. DuPont de Nemours & Co., Wilmington, Del.; and POLYBUTENE-1™ from Basell Polyolefins, Wilmington, Del.), elastomeric styrenic block copolymers (e.g., those available under the trade designations KRATON™ from Kraton Polymers, Houston, Tex.; and SOLPRENE™ from Dynasol Elastomers, Houston, Tex.) and polyether block copolyamide elastomeric materials (e.g., those available under the trade designation PEBAX™ from Arkema, Colombes, France).

A variety of natural fiber-forming materials may also be made into nonwoven microfibers according to embodiments of the present disclosure. Preferred natural materials may include bitumen or pitch (e.g., for making carbon fibers). The fiber-forming material can be in molten form or carried in a suitable solvent. Reactive monomers can also be employed, and reacted with one another as they pass to or through the die. The nonwoven webs may contain a mixture of fibers in a single layer (made for example, using two closely spaced die cavities sharing a common die tip), a plurality of layers (made for example, using a plurality of die cavities arranged in a stack), or one or more layers of multi-component fibers.

In certain embodiments, the population of fibers may be oriented. Oriented fibers are fibers where there is molecular orientation within the fiber. Fully oriented and partially oriented polymeric fibers are known and commercially available.

Fibers also may be formed from blends of materials, including materials into which certain additives have been blended, such as pigments or dyes. Bi-component microfibers, such as core-sheath or side-by-side bi-component fibers, may be prepared (“bi-component” herein includes fibers with two or more components, each component occupying a part of the cross-sectional area of the fiber and extending over a substantial length of the fiber), as may be bicomponent micrometer fibers. However, exemplary embodiments of the disclosure may be particularly useful and advantageous with monocomponent fibers (in which the fibers have essentially the same composition across their cross-section, but “monocomponent” includes blends or additive-containing materials, in which a continuous phase of substantially uniform composition extends across the cross-section and over the length of the fiber). Among other benefits, the ability to use single-component fibers reduces complexity of manufacturing and places fewer limitations on use of the web.

The polymeric fibrous web component may comprise monocomponent fibers comprising any one of the above-mentioned polymers or copolymers. In this exemplary embodiment, the monocomponent fibers may contain additives as described below, but comprise a single fiber-forming material selected from the above-described polymeric materials. Further, in this exemplary embodiment, the monocomponent fibers typically comprise at least 75 weight percent of any one of the above-described polymeric materials with up to 25 weight percent of one or more additives. Desirably, the monocomponent fibers comprise at least 80 weight percent, more desirably at least 85 weight percent, at least 90 weight percent, at least 95 weight percent, and as much as 100 weight percent of any one of the above-described polymeric materials, wherein all weights are based on a total weight of the fiber.

The fiber component may also comprise multi-component fibers formed from (1) two or more of the above-described polymeric materials and (2) one or more additives as described below. As used herein, the term “multi-component fiber” is used to refer to a fiber formed from two or more polymeric materials or two or more fiber sizes. Suitable multi-component fiber configurations include, but are not limited to, a sheath-core configuration, a side-by-side configuration, and an “islands-in-the-sea” configuration.

In addition to the fiber-forming materials mentioned above, various additives may be added to the fiber melt and extruded to incorporate the additive into the fiber. Typically, the amount of additives is less than about 25 weight percent, desirably, up to about 5.0 weight percent, based on a total weight of the fiber. Suitable additives include, but are not limited to, particulates, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluorochemicals.

One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density-related, liquid barrier or adhesive tack related properties.

The polymeric fibrous web is further electrically charged. Electrical charging or treating processes suitable for the present disclosure are known in the art. These methods include thermal, plasma-contact, electron beam and corona discharge methods. For example, U.S. Pat. No. 4,375,718 to Wadsworth et al., U.S. Pat. No. 5,401,446 to Tsai et al., and U.S. Pat No. 6,365,088 to Knight et. al., disclose charging processes for nonwoven webs.

Each side of the nonwoven web can be conveniently charged by sequentially subjecting the web to a series of electric fields such that adjacent electric fields have substantially opposite polarities with respect to each other. For example, one side of web is initially subjected to a positive charge while the other side is subjected to a negative charge, and then the first side of the web is subjected to a negative charge and the other side of the web is subjected to a positive charge, imparting permanent electrostatic charges in the web. Charge stability can be further enhanced by grafting polar end groups onto the polymers of the fibers. In addition, barium titanate and other polar materials may be blended with the polymers to enhance the charging treatment. Suitable blends are described in U.S. Pat. No. 6,162,535 to Turkevich et al., and in U.S. Pat. No. 6,573,205 B1 to Myers et al., hereby incorporated by reference. Other methods of electret treatment are known in the art such as that described in U.S. Pat. No. 4,375,718 to Wadsworth, U.S. Pat. No. 4,592,815 to Nakao, U.S. Pat. Nos. 6,365,088, and 4,874,659 to Ando.

In some embodiments, the charged polymeric fibrous webs can be commercially available. Examples of commercially available polymeric fibrous webs include, MERV filters, otherwise known as Minimum Efficiency Reporting Value filters. MERV ratings range from 1 to 20, with 1 being the lowest level of filtration, and 20 being the highest. Filters that are MERV 1 through 20 are particularly useful in the present disclosure, particularly MERV 5 and MERV17 are preferred, and MERV 13 and MERV17 are exemplified herein.

MOF Particles

As described herein, the electret-MOF filter comprises a population of porous metal-organic framework (MOF) particles. The MOF particles comprise at least one at least bidentate organic compound bound by coordination to at least one metal ion. The MOF particles comprise pores which are suitable to adsorb at least one substance. In addition, improved take up of a substance can proceed at comparatively low pressure and having lower pressure drop compared to an electret filter media without the MOF particles.

The metal component in the MOF particles can be selected from the groups IIa, IIIa, IVa to VIIIa and Ib to VIb. Particular preference is given to Mg, Ca, Sr, Ba, Sc, Y, Ti, Zr, Hf, V, Nb, Cr, Mo, Mn, Re, Fe, Co, Rh, Ir, Ni, Pd, Pt, Cu, Ag, Zn, Cd, Hg, B, Al, Ga, In, Tl, Sn, As, Sb and Bi. More preference is given to Zn, Al, Mg, Ca, Cu, Ni, Fe, Pd, Pt, Ru, Rh and Co. In particular preference is given to Zn, Al, Ni, Cu, Mg, Ca, Fe. With respect to the ions of these elements, those which may particularly be mentioned are Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Cr³⁺, Mo³⁺, Mn³⁺, Mn²⁺, Re³⁺, Re²⁺, Fe³⁺, Fe²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Zn²⁺, Cd²⁺, Hg²⁺, Al³⁺, Ga³⁺, In³⁺, Tl³⁺, Sn⁴⁺, Sn²⁺, As⁵⁺, As³⁺, As⁺, Sb⁵⁺, Sb³⁺, Sb⁺, Bi⁵⁺, Bi³⁺ and Bi⁺.

In some instances, the metal ion present in the MOF particles can be selected from Mg, Ca, Sr, Ba, Sc, Ti, Zr, Cr, Mo, W, Mn, Fe, Co, Ni, Pd, Pt, Cu, Zn, Al, Ga, In, Sn, Bi, Cd, Mn, Gd, Ce, or Cr, preferably a transition metal selected from Sc, Ti, V, Cr, Mn, Fe, Co, Ni, Cu, Zn, Al, Zr, Y, Zr, and Mo, more preferably a Period 4, Groups 3-12 metal such as Zn, Fe, Cu, Co, Ni, Ti, or Al, Zr, Y, Zr, or Mo.

The porous MOF particles comprise at least one at least bidentate organic compound bound by coordination to at least one metal ion. MOF particles are described, for example, in U.S. Pat. No. 5,648,508 and EP-A-0790253. The term “at least bidentate organic compound” designates an organic compound which comprises at least one functional group which is able to form, to a given metal ion, at least two (two or more, three or more, or four or more) coordinate bonds to one or more (two or more, three or more, or four or more) metal atoms, in each case one coordinate bond.

As functional groups via which the coordinate bonds can be formed, suitable examples of functional groups are as follow: —CO₂H, —CS₂H, —NO₂, B(OH)₂, —SO₃H, —Si(OH)₃, —Ge(OH)₃, —Sn(OH)₃, —Si(SH)₄, —Ge(SH)₄, —Sn(SH)₃, —PO₃H, AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, where R, for example, is preferably an alkylene group having 1, 2, 3, 4 or 5 carbon atoms, for example a methylene, ethylene, n-propylene, i-propylene, n-butylene, i-butylene, tert-butylene or n-pentylene group, or an aryl group comprising 1 or 2 aromatic nuclei, for example 2C₆ rings which, if appropriate, can be condensed and, independently of one another, can be suitably substituted by at least in each case one substituent, and/or which independently of one another, in each case, can comprise at least one heteroatom, for example N, O and/or S. In some instances, the functional groups can include —CH(SH)₂, —C(SH)₃, —CH(NH₂)₂, —C(NH₂)₃, —CH(OH)₂, —C(OH)₃, —CH(CN)₂ or —C(CN)₃.

The at least two functional groups can in principle be bound to any suitable organic compound, provided that it is ensured that the organic compound having these functional groups is capable of forming the coordinate bond and of producing the framework particles.

Preferably, the organic compounds which comprise the at least two functional groups are derived from a saturated or unsaturated aliphatic compound or an aromatic compound or a compound which is both aliphatic and aromatic. The aliphatic compound or the aliphatic part of the both aliphatic and also aromatic compound can be linear and/or branched and/or cyclic, a plurality of cycles also being possible per compound. Further preferably, the aliphatic compound or the aliphatic part of the both aliphatic and also aromatic compound comprises 1 to 15, such as 1 to 14, 1 to 13, 1 to 12, 1 to 11, or 1 to 10 carbon atoms, for example 1, 2, 3, 4, 5, 6, 7, 8, 9 or 10 carbon atoms.

In some embodiments, dicarboxylic acids such as oxalic acid, succinic acid, tartaric acid, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidodicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200 dicarboxylic acid, 3,6-dioxaoctanedicarboxylic acid, 3,5-cyclohexadiene-1,2-dicarboxylic acid, octadicarboxylic acid, pentane-3,3-carboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyl-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxy-methyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexa-chloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyletherdiimidodicarboxylic acid, 4,4′-diaminodiphenylmethanediimidodicarboxylic acid, 4,4′-diaminodiphenyl-sulfonediimidodicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″—dicarboxylic acid, diphenylether-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzene-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid or 5-ethyl-2,3-pyridinedicarboxylic acid, tricarboxylic acids such as 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid, or tetracarboxylic acids such as 1,1-dioxidoperylo[1,12-BCD]thiophene-3,4,9,10-tetracarboxylic acid, perylenetetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

In some examples, the at least bidentate organic compounds, can comprise acetylenedicarboxylic acid (ADC), benzenedicarboxylic acids, naphthalenedicarboxylic acids, biphenyldicarboxylic acids, for example 4,4′-biphenyldicarboxylic acid (BPDC), bipyridinedicarboxylic acids, for example 2,2′-bipyridinedicarboxylic acids, for example 2,2′-bipyridine-5,5-dicarboxylic acid, benzenetricarboxylic acids, for example 1,2,3-benzenetricarboxylic acid or 1,3,5-benzenetricarboxylic acid (BTC), adamantanetetracarboxylic acid (ATC), adamantanedibenzoate (ADB), benzenetribenzoate (BTB), methanetetrabenzoate (MTB), adamantanetetrabenzoate, or dihydroxyterephthalic acids, for example 2,5-dihydroxyterephthalic acid (DHBDC). In some instances, isophthalic acid, terephthalic acid, 2,5-dihydroxyterephthalic acid, 1,2,3-benezenetricarboxylic acid, 1,3,5-benzenetricarboxylic acid, or 2,2-bipyridine-5,5′-dicarboxylic acid can be used.

In some examples, the organic portion of the MOF particles can be derived from an aromatic carboxylate ligand (e.g., imidazole-based ligands, benzyl or naphthyl carboxylate based ligands).

In some instances, the MOF particles can comprise one or more monodentate ligands.

The MOF particles can be chemically or physically functionalized for tuning their binding selectivity, improve coating uniformity, reduce relative humidity (RH) effects on toluene efficiency reduction, improve stability in hydrophilic or hydrophobic environments, or a combination thereof. For example, the MOF particles can be functionalized with PDMS to improve the particles stability in hydrophobic environments, improve coating uniformity, and reduce relative humidity (RH) effects on toluene efficiency reduction, or a combination thereof.

The MOF particles comprise pores, in particular MOF particles can be micropores and/or mesopores. Micropores are defined as pores having a diameter of 2 nm or less and mesopores are defined by a diameter in the range from 2 nm to 50 nm. The presence of micropores and/or mesopores can be studied using sorption measurements, these measurements determining the absorption capacity of the MOF particles for nitrogen at 77 Kelvin as specified in DIN 66131 and/or DIN 66134.

The pore size of the MOF particles can be controlled by selection of the suitable ligand and/or of the at least bidentate organic compound. The MOF particles can be microporous having an average pore size of less than 2 nm (e.g., from 0.2 nm to 2 nm or from 0.2 nm to 1.5 nm). The MOF particles, however, can have larger pores and thus, the size distribution of which can vary. For example, the MOF particles can have pore sizes ranging from 0.2 nm to 30 nm, such as from 0.3 nm to 3 nm. In the MOF particles, more than 50% of the total pore volume, in particular more than 75%, is formed by pores having a pore diameter of less than 2 nm. Preferably, a majority of the pore volume can be formed by pores of a single average diameter range. In some cases, however, a majority of the pore volume can be formed by pores of two average diameter range. For example, more than 25% of the total pore volume, in particular more than 50% of the total pore volume, can be formed by pores which are in a diameter range of less than 2 nm, and more than 15% of the total pore volume, in particular more than 25% of the total pore volume, can be formed by pores which are in a diameter range of up to 10 nm. The pore distribution can be determined by means of mercury porosimetry.

The MOF particles can be microporous (exhibiting a type I adsorption isotherms at 77 K with no hysteresis) and have an average pore size of 2 nm or less (e.g., 1.8 nm or less, 1.6 nm or less, 1.5 nm or less, 1.3 nm or less, 1.2 nm or less, 1 nm less, 0.9 nm or less, 0.8 nm or less, 0.7 nm or less, 0.6 nm or less, 0.5 nm or less, or 0.4 nm or less). The MOF particles can have an average pore size of 0.1 nm or greater (e.g., 0.2 nm or greater, 0.3 nm or greater, 0.5 nm or greater, 0.6 nm or greater, 0.7 nm or greater, 0.8 nm or greater, 1 nm or greater, 1.2 nm or greater, 1.5 nm or greater, or 1.8 nm or greater). The MOF particles can have an average pore size from 0.2 to 2 nm (e.g., from 0.2 to 1.8 nm, from 0.2 to 1.5, from 0.2 to 1 nm, from 0.5 to 2 nm, from 0.5 to 1.5 nm, or from 0.5 to 1 nm).

The MOF particles can have a pore volume of at least 0.1 cm³/g (e.g., at least 0.2 cm³/g, at least 0.3 cm³/g, at least 0.4 cm³/g, at least 0.5 cm³/g, at least 0.6 cm³/g, at least 0.7 cm³/g, at least 0.8 cm³/g, at least 0.9 cm³/g, or at least 1 cm³/g).

The average surface area, determined from BET method for the MOF particles, can be 500 m²/g or greater, (e.g., 600 m²/g or greater, 800 m²/g or greater, 1,000 m²/g or greater, 1,200 m²/g or greater, 1,500 m²/g or greater, 1,800 m²/g or greater, 2,000 m²/g or greater, 2,200 m²/g or greater, 2,500 m²/g or greater, 3,000 m²/g or greater, 4,000 m²/g or greater, up to 5,000 m²/g, up to 6,000 m²/g, up to 7,000 m²/g, up to 8,000 m²/g, up to 9,000 m²/g, up to 10,000 m²/g, up to 11,000 m²/g, up to 12,000 m²/g, up to 12,000 m²/g, or up to 14,000 m²/g), as determined using multiple layer BET method. The MOF particles can have an average surface area of 14,000 m²/g or less (e.g., 13,000 m²/g or less, 12,000 m²/g or less, 11,000 m²/g or less, 10,000 m²/g or less, 9,000 m²/g or less, 8,000 m²/g or less, 7,000 m²/g or less, 6,000 m²/g or less, 5,000 m²/g or less, 4,000 m²/g or less, 3,500 m²/g or less, 3,000 m²/g or less, 2,500 m²/g or less, 2,000 m²/g or less, or 1,500 m²/g or less), as determined using multiple layer BET method. The MOF particles can have an average surface area of from 500 m²/g to 14,000 m²/g (e.g., 500 m²/g to 10,000 m²/g, 500 m²/g to 5,000 m²/g, 1,000 m²/g to 5,000 m²/g, 1,000 m²/g to 4,000 m²/g, or 800 m²/g to 5,000 m²/g), as determined using multiple layer BET method.

The MOF particles can have an average particle size, wherein their longest dimension is 5 microns or less (e.g., 4.5 microns or less, 4 microns or less, 3.5 microns or less, 3 microns or less, 2.5 microns or less, 2 microns or less, 1.5 microns or less, 1.3 microns or less, 1 micron or less, 0.9 microns or less, 0.8 microns or less, 0.7 microns or less, 0.6 microns or less, 0.5 microns or less, or 0.4 microns or less). The MOF particles can have an average particle size, wherein their longest dimension is 0.1 micron or greater (e.g., 0.2 microns or greater, 0.3 microns or greater, 0.5 microns or greater, 0.6 microns or greater, 0.7 microns or greater, 0.8 microns or greater, 1 micron or greater, 1.2 microns or greater, 1.5 microns or greater, 2 microns or greater, 2.5 microns or greater, 3 microns or greater, 3.5 microns or greater, or 4 microns or greater). The MOF particles can have an average particle size, wherein their longest dimension is from 0.1 to 5 microns (e.g., from 0.2 to 5 microns, from 0.1 to 3 microns, from 0.1 micron to 1.5 micron, from 0.5 to 1.5 microns, from 0.5 micron to 3 microns, or from 0.5 to 1.5 microns).

Specific examples of MOF particles that can be used in the electret-MOF filter disclosed herein include, but are not limited to, MIL-125—NH₂, UiO-66-NH₂, ZIF-67, MOF-2 to 4, MOF-9, MOF-31 to 36, MOF-39, MOF-69 to 80, MOF103 to 106, MOF-122, MOF-125, MOF-150, MOF-177, MOF-178, MOF-235, MOF-236, MOF-500, MOF-501, MOF-502, MOF-505, IRMOF-1, IRMOF-61, IRMOP-13, IRMOP-51, MIL-17, MIL-45, MIL-47, MIL-53, MIL-59, MIL-60, MIL-61, MIL-63, MIL-68, MIL-79, MIL-80, MIL-83, MIL-85, CPL-1 to 2, SZL-1 which are described in the literature.

As discussed above, multiple types of particles may also be used within a single polymeric fibrous web. In some embodiments, it may be advantageous to use at least one additional sorbent particulate, for example, an absorbent, an adsorbent, activated carbon, an anion exchange resin, a cation exchange resin, a molecular sieve, or a combination thereof. Desirably the sorbent particles will be capable of absorbing or adsorbing gases, aerosols or liquids expected to be present under the intended use conditions. The sorbent particles can be in any usable form including beads, flakes, granules or agglomerates. Preferred sorbent particles include activated carbon; alumina and other metal oxides; sodium bicarbonate; metal particles (e.g., silver particles) that can remove a component from a fluid by adsorption, chemical reaction, or amalgamation; particulate catalytic agents such as hopcalite (which can catalyze the oxidation of carbon monoxide); clay and other minerals treated with acidic solutions such as acetic acid or alkaline solutions such as aqueous sodium hydroxide; ion exchange resins; molecular sieves and other zeolites; silica; biocides; fungicides and virucides. Activated carbon and alumina are particularly preferred sorbent particles. Mixtures of sorbent particles can also be employed, e.g., to absorb mixtures of gases, although in practice to deal with mixtures of gases it may be better to fabricate a multilayer sheet article employing separate sorbent particles in the individual layers.

The electret-MOF filter can comprise the MOF particles in an amount of up to 30% by weight of the electret-MOF filter (e.g., 1% by weight or greater, 2% by weight or greater, 3% by weight or greater, 4% by weight or greater, 5% by weight or greater, 6% by weight or greater, 8% by weight or greater, 10% by weight or greater, 12% by weight or greater, 15% by weight or greater, 18% by weight or greater, 20% by weight or greater, 22% by weight or greater, 25% by weight or greater, 28% by weight or greater, or up to 30% by weight or greater). The electret-MOF filter can comprise the MOF particles in an amount of 30% by weight or less (e.g., 28% by weight or less, 25% by weight or less, 22% by weight or less, 20% by weight or less, 18% by weight or less, 15% by weight or less, 12% by weight or less, 10% by weight or less, 8% by weight or less, 7% by weight or less, 6% by weight or less, 5% by weight or less, or 4% by weight or less). The electret-MOF filter can comprise the MOF particles in an amount from 2% up to 30% by weight (e.g., from 1% to 30% by weight, from 3% to 30% by weight, from 5% to 30% by weight, from 3% to 25% by weight, from 5% to 25% by weight, from 3% to 20% by weight, from 5% to 20% by weight, from 10% to 30% by weight, from 10% to 25% by weight, or from 10% to 20% by weight).

Additional Layers

As described herein, the electret-MOF filter includes a polymeric fibrous web. The media may further comprise a support layer. When present, the support layer may provide strength to the electret-MOF filter article. A multi-layer electret-MOF filter structure may also provide sufficient strength for further processing. A variety of support layers may be used including, but are not limited to, a nonwoven fabric, a woven fabric, a knitted fabric, a foam layer, a film, a paper layer, an adhesive-backed layer, a foil, a mesh, an elastic fabric (i.e., any of the above-described woven, knitted or nonwoven fabrics having elastic properties), an apertured web, an adhesive-backed layer, or any combination thereof. In one exemplary embodiment, the support layer comprises a polymeric nonwoven fabric. Suitable nonwoven polymeric fabrics include, but are not limited to, a spunbonded fabric, a melt blown fabric, a carded web of staple length fibers (i.e., fibers having a fiber length of less than about 100 mm), a needle-punched fabric, a split film web, a hydroentangled web, an air laid staple fiber web, or a combination thereof. In certain exemplary embodiments, the support layer comprises a web of bonded staple fibers. As described further below, bonding may be effected using, for example, thermal bonding, adhesive bonding, powdered binder bonding, hydroentangling, needle punching, calendering, or a combination thereof.

The support layer may have a basis weight and thickness depending upon the particular end use of the electret-MOF filter article. In some embodiments of the present disclosure, it is desirable for the overall basis weight and/or thickness of the electret-MOF filter article to be kept at a minimum level. In other embodiments, an overall minimum basis weight and/or thickness may be required for a given application. Typically, the support layer has a basis weight of less than about 150 gsm. In some embodiments, the support layer has a basis weight of from about 5.0 gsm to about 100 gsm. In other embodiments, the support layer has a basis weight of from about 10 gsm to about 75 gsm.

As with the basis weight, the support layer may have a thickness, which varies depending upon the particular end use of the electret-MOF filter article. Typically, the support layer has a thickness of less than about 150 millimeters (mm). In some embodiments, the support layer has a thickness of from about 1.0 mm to about 35 mm In other embodiments, the support layer has a thickness of from about 2.0 mm to about 25 mm In certain exemplary embodiments, the support layer may comprise a microfiber component, for example, a plurality of microfibers. The polymeric fibrous web component may be permanently or temporarily bonded to a given support layer.

In one exemplary embodiment, the support layer comprises a spunbonded fabric comprising polypropylene fibers. In a further exemplary embodiment of the present disclosure, the support layer comprises a carded web of staple length fibers, wherein the staple length fibers comprise: (i) low-melting point or binder fibers; and (ii) high-melting point or structural fibers. Suitable binder fibers include, but are not limited to, any of the above-mentioned polymeric fibers. Suitable structural fibers include, but are not limited to, any of the above-mentioned polymeric fibers, as well as inorganic fibers such as ceramic fibers, glass fibers, and metal fibers; and organic fibers such as cellulosic fibers.

As described above, the support layer may comprise one or more layers in combination with one another. In one exemplary embodiment, the support layer comprises a first layer, such as a nonwoven fabric or a film, and an adhesive layer on the first layer opposite the sub-micrometer fiber component. In this embodiment, the adhesive layer may cover a portion of or the entire outer surface of the first layer. The adhesive may comprise any known adhesive including pressure-sensitive adhesives, heat activatable adhesives, etc. When the adhesive layer comprises a pressure-sensitive adhesive, the electret filter material article may further comprise a release liner to provide temporary protection of the pressure-sensitive adhesive.

The electret-MOF filter may comprise additional layers in combination with the particulate-loaded fiber layer, the optional support layer, or both of the above. Suitable additional layers include, but are not limited to, a color-containing layer (e.g., a print layer); any of the above-described support layers; one or more additional sub-micrometer fiber components having a distinct average fiber diameter and/or physical composition; one or more secondary fine sub-micrometer fiber layers for additional insulation performance (such as a melt-blown web or a fiberglass fabric); foams; layers of particles; foil layers; films; decorative fabric layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof.

Optional Attachment Devices

In certain exemplary embodiments, the electret-MOF filter may further comprise one or more attachment devices to enable the electret-MOF filter article to be attached to a substrate. As discussed above, an adhesive may be used to attach the electret-MOF filter article. In addition to adhesives, other attachment devices may be used. Suitable attachment devices include, but are not limited to, any mechanical fastener such as screws, nails, clips, staples, stitching, thread, hook and loop materials, etc. The one or more attachment devices may be used to attach the electret-MOF filter article to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); a surface of a pipe or hose; a computer or electronic component; a sound recording or reproduction device; a housing or case for an appliance, computer, etc.

In some examples, the electret-MOF filter can be incorporated into several devices including, but not limited to, a respirator filter, a room or building ventilation system filter, a vehicle, train, bus and airplane ventilation system filter, an air conditioner filter, a furnace filter, a room air purifier filter, a vacuum cleaner filter, or a computer disk drive filter.

Properties

As described herein, the electret-MOF filter can simultaneously remove fine particulate matter (PMs) and hazardous gaseous pollutants with high particle holding and gas adsorption capacities, and with very low air resistance. In particular the electret-MOF filter can filter out E3 (3.0-10.0 μm) particles, E2 (1.0-3.0 μm) particles, and E1 (0.3-1.0 μm) particles. For example, the electret-MOF filter can filter particles including pollen, dust, dust mites, mold, bacteria, pet dander, cooking oil smoke, smoke, smog, virus carriers, in addition to volatile organic compounds. Further, the pressure drop of the electret-MOF filter are low, and barely different if not improved compared to the pressure drop of the fibrous web alone.

In some embodiments, the electret-MOF filter exhibits a volatile organic compound (VOC) load reduction of at least 75% (at least 80%, at least 85%, or at least 90%), when tested at a VOC concentration of 5 ppm with 5 cm s⁻¹ face velocity. In some embodiments, the electret-MOF filter exhibits a PM_{2.5} load reduction of at least 80% in mass, when tested under 5 cm s⁻¹ face velocity. The pressure drop due to MOF particle depositions was also reasonably comparable to the original fibrous electret web. In some examples, the air resistance of the electret-MOF filter can be such that the filter media only exhibit a pressure drop of less than 50 Pa, tested at 5 cm/s (Pa). The electret-MOF filter can also exhibit a charge retention of at least 95%, tested using a water soaking-drying tests.

The electret-MOF filter also demonstrated high toluene removal efficiency. PM aging tests were conducted and results showed that the PM holding capacity had no impairment compared with clean fibrous electret webs.

Electret-MOF filter embedded with metal-organic frameworks (MOFs) having a high surface area are disclosed and exhibit a capacity for simultaneous removal of fine particulate matters (PMs) and volatile organic compounds (VOCs). With appropriate modification of the functional groups on the MOF particles, extra chemisorption, in addition to physisorption, takes place to further improve the efficiency of harmful gas removal.

Methods

A process for simultaneously adsorbing particulate and volatile organic compounds in a gaseous environment, such as air, are disclosed. The process can include contacting with the environment an electret-MOF filter disclosed herein. The volatile organic compounds may be present at a concentration in the range of 0.01 ppm to 50 ppm and include compounds such as acetic acid, acetaldehyde, formaldehyde, toluene, or a combination thereof.

Numerous characteristics and advantages provided by aspects of the present disclosure have been set forth in the foregoing description and are set forth in the attached Appendix, together with details of structure and function. While the present disclosure is disclosed in several forms, it will be apparent to those skilled in the art that many modifications can be made therein without departing from the spirit and scope of the present disclosure and its equivalents. Therefore, other modifications or embodiments as may be suggested by the teachings herein are particularly reserved.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### Simultaneous Removal of VOCs and PM_{2.5} by Metal-Organic Framework Coated Electret Filter Media

Abstract: The electret filter media coated with highly porous metal-organic frameworks (MOFs) particles, named E-MOFilter, is developed and evaluated for its capacity for simultaneous removal of fine particulate matters (PM_{2.5}) and volatile organic compounds (VOCs). Three different MOFs particles, including MIL-125-NH₂, UiO-66-NH₂, and ZIF 67, were synthesized and systematically characterized. The produced MOF particles were suspended in ultrapure water and then a liquid filtration apparatus was used to deposit the MOF particles onto two electret media with different minimum efficiency reporting values (MERV 13 and 17) to form the E-MOFilters. Results showed that the MOF particles deposited in MERV 13 media more uniformly than that of MERV 17. In the PM filtration tests, results showed that the E-MOFilter gained only a few more pascals of air resistance compared with clean electret media. Besides, its PM removal efficiency was found to be close to that of clean electret media. This indicates that a uniform MOF particle deposition and negligible charge degradation from the current coating process were obtained. Further, the E-MOFilter with MIL-125-NH₂ particle coating not only had a decent toluene removal efficiency (>80%) but also maintained its original PM_{2.5} holding capacity. This work may shed light on applying the novel E-MOFilter in the residential and commercial HVAC systems and indoor air purifiers to simultaneously and effectively remove PM_{2.5} and VOCs.

Introduction: Metal-organic frameworks (MOFs), a novel class of porous crystalline polymers, have large surface areas, tailorable pore sizes, tunable functionalities, and relatively high thermal stability and selectivity, which make them promising candidates for gas capture, gas separation and drug delivery, catalysis, sensing, etc. MOFs are constructed from metal ions and organic ligands. Such materials offer significant chemical and structural diversity. In this example, for the first time electret filter media is combined with MOF particles, named E-MOFilter, to mitigate PM_{2.}s and VOCs simultaneously. Three MOF particles, including MIL-125-NH₂, UiO-66-NH₂ and ZIF-67, were selected and synthesized for the fabrication of E-MOFilters. These MOFs were chosen due to their small pore sizes, high surface areas, and special functionalities, enabling a promising adsorption of VOCs. In the aspect of electret filter, two electret filters with different minimum efficiency reporting values (MERVs), i.e., MERV 13 and MERV 17, were used as base substrates for the deposition of MOF particles. The effects of fiber diameter and porosity on the uniformity of MOF particles depositions were studied. The E-MOFilters were tested not only for their initial efficiency but also holding and adsorption capacity for PM_{2.5} and toluene (a common indoor VOC pollutant). The ultimate goal of this study is to demonstrate the E-MOFilter and the developed fabrication method not only maintain the charge of electret media but also keep high removal efficiency and holding capacity for PM_{2.5}. Besides, the E-MOFilter has high efficiency and high adsorption capacity for VOCs.

Materials and Methods

Electret filter media: The flat sheets of the MERV 13 and MERV 17 rated electret filter media were used for the deposition of MOF particles and subsequent PM and toluene removal tests. To be noted that the MERV 17 rated filter is equivalent to the high efficiency particulate air (HEPA) filter which has a 99.97% efficiency in the removal of 0.3 μm particles. Therefore, the MERV 17 will be labeled as ‘HEPA’ throughout the rest of the example. The filter specifications of these two media are summarized in Table 1. As can be seen, the HEPA media have a much smaller fiber diameter (major layer) than that of MERV 13. It is expected that the HEPA media would be relatively easier for the deposition of MOF particles onto its fibers by sieving mechanism in the liquid filtration (coating) process. Since the MERV 13 has a relatively low pressure drop and its PM removal efficiency may not be high enough, this study intended to use two layers of MERV 13, in addition to 1 layer, to see if the PM and toluene removal efficiency can be further improved. In comparison, due to the existing high pressure and good PM efficiency, the HEPA will be tested with 1 layer only.

TABLE 1
Specification of the HEPA and MERV 13
electret media for the MOF coating.

| | | |
|---|---|---|
| Types | HEPA (MERV 17) | MERV 13 |

| | | | |
|---|---|---|---|
| Fiber diameter (μm) | 2.0 ± 0.5 | (fine fibers) | 13.1 ± 0.9 |
| | 80 ± 5 | (coarse fibers) | |

| | | |
|---|---|---|
| Thickness (mm) | 0.5 ± 0.03 (0.11 ± 0.01, | 0.47 ± 0.02 |
| | excluding coarse fiber layer | |
| Basic weight (g/m²) | 72 ± 2 (22 ± 1 without | 75 ± 2 |
| | coarse fiber layer) | |
| Solidity (α) | 0.102 | 0.104 |
| Charging density | 80 | 50 |
| (μC/m²) | | |
| Initial pressure | 46.2 ± 0.7 | 4.5 ± 0.1 |
| drop at 5 cm/s (Pa) | | |
| Initial efficiency for | 99.97 ± 0.01 | 91.11 ± 0.23 |
| 0.3 μm particles (%) | | |

Synthesis of MOFs particles: Three types of MOFs, including MIL-125-NH₂, UiO-66-NH₂ and ZIF-67, were selected and synthesized to fabricate the E-MOFilters. These materials were chosen due to their small pore size, high surface area, and special functionalities, but also their water stability and proper size facilitating the liquid filtration coating to the electret media, which will be shown later. The three MOFs were synthesized following the procedures reported in the literature with slight modifications. Briefly, for MIL-125-NH₂, 0.797 mL titanium tetraisopropoxide (TTIP) and 0.651 g 2-aminoterephthalic acid (BDC-NH₂) were dissolved in the mixture of dimethylformamide (DMF)/methanol (15 mL/15 mL). Then, the mixture was transferred to a Teflon-lined steel autoclave reactor and placed in an oven at 150° C. for 15 hours. The obtained yellow products were isolated by centrifugation and washed by 30 mL DMF and 30 mL methanol, respectively, for three times. Finally, the samples were dried under 50° C. overnight in vacuum. For UiO-66-NH₂, 1.875 g ZrCl₄ (pre-dissolved in a mixture of DMF/HCl, 75 mL/15 mL) and 2.011 g BDC-NH₂ (pre-dissolved in DMF 150 mL) were mixed and heated at 80° C. for 3 hours. Then the obtained powders were isolated by centrifugation and washed with 45 mL DMF for three times. Similarly, the product was dried under vacuum at 50° C. overnight. In synthesizing ZIF-67, 0.3577 g cobalt nitrate hexahydrate (pre-dissolved in 25 mL methanol) and 0.4062 g 2-methylimidazolate (pre-dissolved in 25 mL methanol) were mixed and stirred at room temperature for 24 hours. Then the obtained products were isolated by centrifugation and washed with 30 mL methanol for two times. The products were also dried under vacuum at 50° C. overnight.

Preparation of E-MOFilters: In general, there are many ways to incorporate MOF particles with the filter media, including in situ interweaving, electrospinning (physical blending of MOF nanoparticles with polymers, producing MOF-based nanofibers), freeze-drying, hot-pressing, roll-to-roll processing, air filtration deposition, etc. To choose an appropriate method for the current example, the following considerations were taken into account in the process of combining the MOF particles with the charged fibers. Firstly, the charges of the electret media should not be degraded; secondly, the MOF particles should firmly attach to the electret media with a minimized growth of air resistance; thirdly, the transfer process is simple and cost-efficient. Reviewing the abovementioned methods, none of them is applicable. For example, the interweaving could not tightly hold the MOF particles and particle shedding during filtration may occur; both freeze-drying and hot pressing would experience harsh temperature or pressure changes, therefore, the degradation for fiber charges is unavoidable; the roll-to-roll can also cause shedding issue; and the air filtration always leads to a non-uniform deposition of particles in depth of the media.

As none of the existing methods were appropriate, this example proposed a liquid filtration (coating) method to fabricate the E-MOFilters. The choice of liquid filtration is to utilize the inherent more uniform particle deposition in liquid filtration process especially in the case of pore to particle diameter ratio is not low, e.g., 5-20. Besides, the inventors have found that there was a negligible charge degradation in water soaking-drying tests for electret media. If the MOF particles can be uniformly coated onto the fibers and in depth of the media without the formation of particle cake, the applied quantity of MOF particles and the increase of air resistance can be minimized (lower than dendrite structure in air filtration), therefore, the shielding of charge by the MOF particles should be minimized. Besides, the VOC removal efficiency should be maximized due to the high surface area of MOF particles. FIG. 1 shows the experimental setup for the MOF coating. The MOF particles were first suspended in water with a concentration of 0.02 wt %. There were still some minor loading effects causing the upper layers of the media to collect a little more MOF particles than the lower layers. Therefore, the coating flow (or filtration direction) was introduced from the back side of the filter to reduce the deposition quantity of MOF particles on the first few layers of the E-MOFilters. Thus, the attenuation of PM removal efficiency and holding capacity due to charge shielding and reduction in void space by MOF particles can be avoided. The driving force for the flow circulation in the system was provided by a peristaltic pump under the flow rate of 100 mL·min⁻¹. The coating levels and applied substrates (HEPA or MERV 13) in the fabrications of E-MOFilters are summarized in Table 2 below. In brief, the quantities of the coated MOFs were controlled at 5 (low), 10 (medium) and 25 (high) wt %, of the mass of MERV 13 (1 or 2 layer) and HEPA (1 layer) flat sheet with 47 mm in diameter. For example, the one with 5 wt % low coating uses MOF particles for only 3.75 g per square meter of filter.

TABLE 2
Fabrications of E-MOFilters and experimental conditions
for PM and Toluene tests of E- MOFilters.

| E-MOFilters | | | | PM tests | Toluene tests | |
|---|---|---|---|---|---|---|
| | | Coating level | | a. Initial | Challenging | |
| | MOF | (wt % of | | efficiency | concentration | Face velocity |
| Substrate | particles | media mass) | | b. Aging test | 5 ppm | (cm/s) |
| HEPA | ZIF-67 | High | (25%) | None | 1 layer | 5 |
| (1 layer) | UiO-66-NH₂ | High | (25%) | None | | |
| | MIL-125-NH₂ | High | (25%) | a | | |
| MERV 13 | MIL-125-NH₂ | Low | (5%) | a and b (only | Both 1 and | |
| (1 or 2 | | | | for 2 layers) | 2 layers | |
| layers) | | Medium | (10%) | a and b (only | | |
| | | | | for 2 layers) | | |
| | | High | (25%) | a and b (only | | |
| | | | | for 2 layers) | | |
| MERV 13 | MIL-125-NH₂ | High | (25%) | Simultaneous | 2 layers | 5 |
| (2 layers) | | | | loading/no PM | | |
| | | | | measurement | | |

Characterization of MOF particles and E-MOFilters: To characterize the MOF particles, the scanning electron microscopy (SEM, HITACHI SU-70, HITACHI Corp., Tokyo, Japan), X-ray diffraction (XRD, PANalytical X'Pert Pro, Malvern PANalytical Ltd., Malvern, UK) and Fourier transform infrared spectroscopy (FT-IR, Nicolet iS50, Thermo Fisher Scientific, Waltham, Mass.) were utilized to probe the size, morphology, structure, and surface chemistry of the MOF particles, respectively. To measure Brunauer-Emmett-Teller (BET) surface areas of the MOF particles and E-MOFilters, N₂ adsorption/desorption isotherms was measured by a gas sorption analyzer (Autosorb iQ, Quantachrome Instruments Corp., Boynton Beach, Fla.). In addition to the surface area, the pore diameter distribution was obtained based on the density functional theory (DFT). The SEM, FT-IR and XRD analysis was also conducted for E-MOFilter to evaluate the coating uniformity of MOF particles and whether there are interactions between electret media and MOF particles.

Initial efficiency of E-MOFilters for PMs: After the characterization of MOF particles and E-MOFilters, E-MOFilters were evaluated for their PM and VOC removals. A difficulty was encountered when the VOC and PM removal efficiency by the E-MOFilter was intended to be measured simultaneously. The filtration speed varied for VOC filtration as the flow needed to be switched periodically to measure the upstream or downstream particle concentration for determining the PM efficiency. Therefore, this example conducted the PM initial efficiency and PM aging tests first followed by the VOC removal efficiency and adsorption tests of the E-MOFilters and the tests with a reverse order were conducted to confirm the order would not cause many differences. Besides, a system close to the simultaneous measurement for PM_{2.5} and VOC was developed, shown in FIG. 2 in which the PM_{2.5} was continuously introduced to challenge the E-MOFilter (MIL-125-NH₂ coated MERV13 with high level) but the efficiency was not characterized. If the three results are close to each other, the experimental data obtained from the separate measurements should be applicable to the real operating condition. Table 2 summarizes the test conditions for the E-MOFilters against PM and VOC.

PM_{2.5} are generated according to the operation condition as previously applied and they meet toluene at a mixing chamber. Then the mixture of PM_{2.5} and toluene are introduced to filter holder to challenge the E-MOFilter. The upstream and downstream toluene concentrations are being monitored by the GC by switching the 3-way valve to the dummy and filter holder, respectively. The efficiency of the E-MOFilter against PM_{2.5} is not determined, nevertheless, from the GC results it will become clear that if the simultaneously introduced PM_{2.5} can cause any side effects for the toluene adsorption.

The initial PM removal efficiency of E-MOFilter was tested under 5 cm s⁻¹ face velocity (commonly used in literature). In brief, atomization (Model 9302, TSI Inc., Shoreview, Minn.) and classification (Model 3082, TSI Inc., Shoreview, Minn.) were utilized to produce monodisperse NaCl particles with sizes of 20-700 nm. The classified monodisperse particles were firstly neutralized to reach Boltzmann distribution to minimize and mimic the particles present in the ambient condition before being introduced to challenge the E-MOFilters. The upstream, Cᵤₚ, and downstream, C_{down}, particle concentrations (particle cm⁻³) were measured by an ultrafine condensation particle counter (UCPC, Model 3776, TSI Inc., Shoreview, Minn.). Then the initial size-fractioned efficiency, η%, can be determined as:

$$η \% = ( 1 - \frac{{C}_{d o w n}}{{C}_{u p}} ) \times 100 \% \qquad ( 1 )$$

For comparison, the initial efficiency of original and discharged (by IPA vapor) HEPA and MERV 13 electret media without coating MOF particles was also measured [45]. Because of the application of classification technique which produced monodisperse particles with low concentration, the loading effect was negligible and would not affect the PM aging tests.

PM Aging Test

The PM aging tests were conducted for the MIL-125-NH₂ coated E-MOFilters only as will be shown later the MIL-125-NH₂ performed the best VOC removal amongst the three MOFs. Similarly, E-MOFilters with three coating levels together with the original electret media will be aged under 5 cm s⁻¹ by PMs with a close size distribution of ambient PM_{2.5}. The average number median diameter (NMD) and mass median diameter (MMD) of the NaCl particles used to challenge the E-MOFilter media were ˜80 nm and ˜500 nm, respectively. The aging tests were conducted under a relative humidity (RH) of ˜30%, a relatively dry condition to simulate the worst condition of aging. The details of the experiments and method to determine the holding capacity, in terms of pressure drop growth versus mass load, can be found elsewhere.

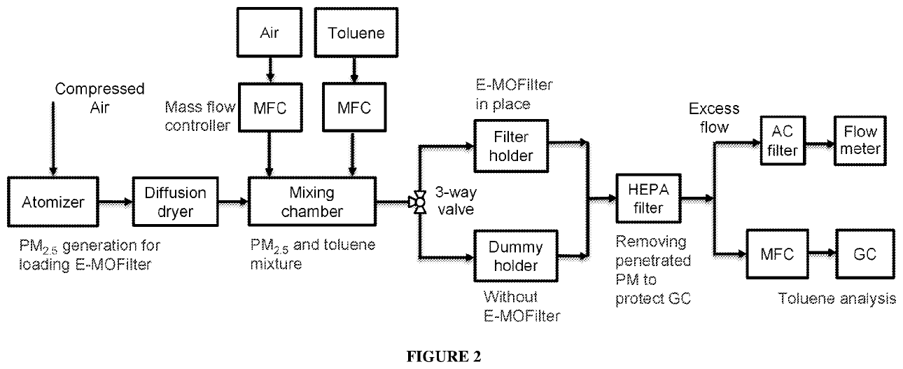

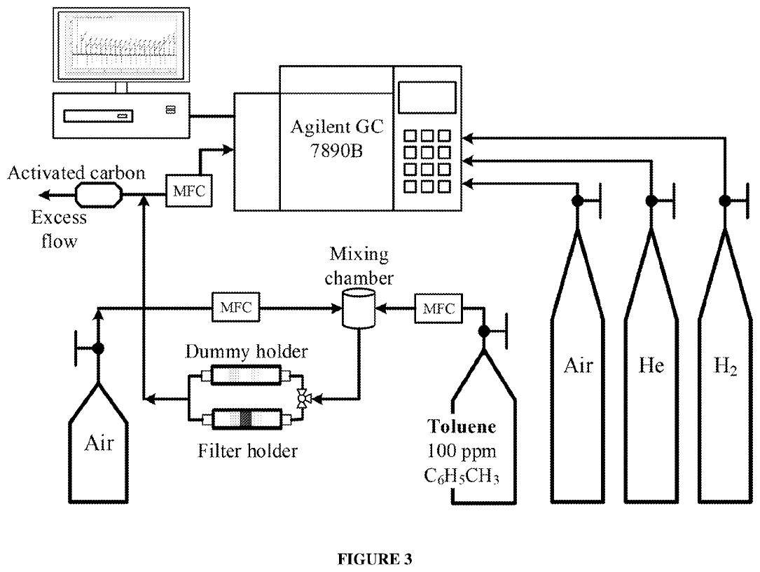

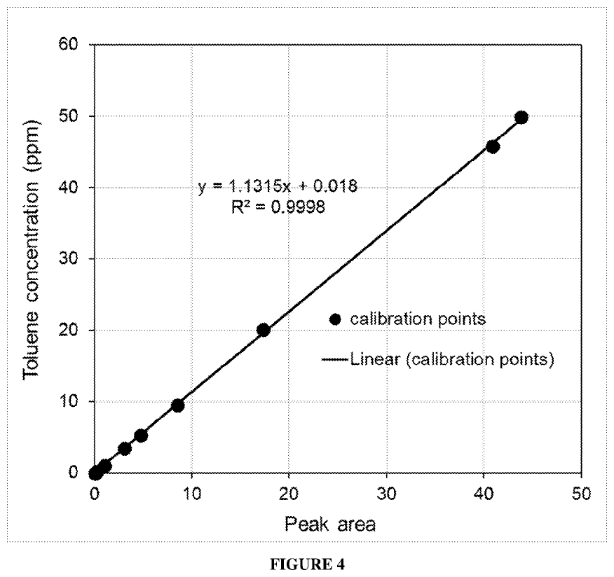

Removal efficiency and adsorption capacity of toluene by E-MOFilters: The toluene (C₆H₅CH₃) as a common and representative harmful VOC in indoor air, was selected to challenge the E-MOFilters. The experimental setup was shown in FIG. 3 and FIG. 2 (for simultaneous PM_{2.5} loading), in which a gas chromatography (GC, Agilent 7890B, Agilent Technologies Inc., Santa Clara, Calif.) equipped with a flame ionization detector (FID, Agilent Technologies Inc., Santa Clara, Calif.) was adopted to measure the toluene concentration. In the GC-FID measurement, three minutes for each run and 30 seconds for each sampling was set. The line of the dummy holder was used to generate the calibration curve, from 0.05 to 50 ppm, for the toluene. Results showed that the relationship between the toluene concentration and peak area had a root square of 0.999 (FIG. 4).

In this study, 5 ppm of toluene with the 5 cm s⁻¹ of face velocity were applied for testing. When the measurement started, the toluene flow was introduced to the dummy line first to confirm if a correct toluene concentration was used. Then the flow was switched to the E-MOFfilter line by the three-way valve. Usually, the third or fourth peak of the measurement shows the lowest peak area, i.e., the lowest toluene concentration. Thus, using Eq. (1), the initial removal efficiency of toluene, η%, can be determined from the toluene concentration measured from the dummy line representing the upstream concentration of the E-MOFilter, Cᵤₚ, and the lowest concentration from the E-MOFilter line, representing the downstream concentration, C_{down}. When the toluene flow continued passing the E-MOFilter line, the breakthrough curve, or the adsorption capacity, was determined. To obtain the representative results, measurements for each experimental condition in toluene and PM tests were repeated four times.

Results and Discussion

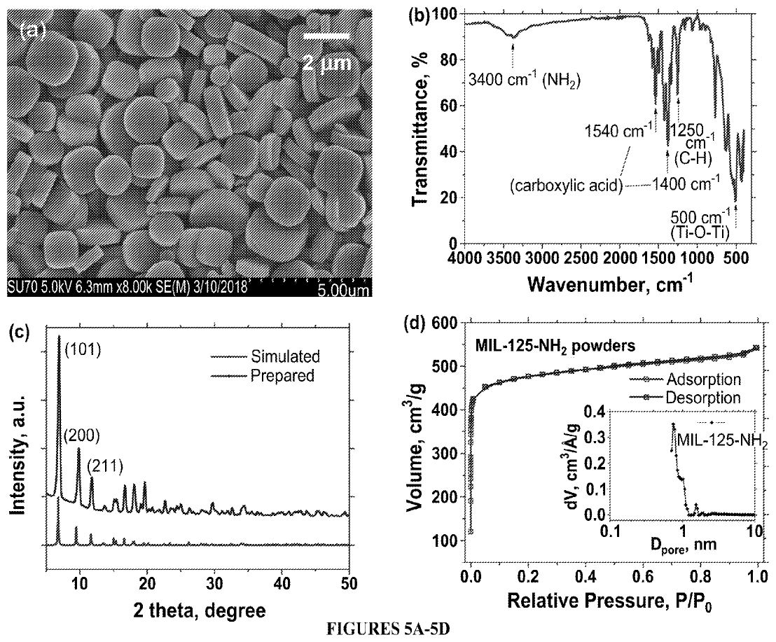

Characterization of MOF particles: FIG. 5 summarizes the characterization results of MIL-125-NH₂ particles, including SEM image, FT-IR spectrum, XRD patterns, and BET analysis for pore diameter, Dₚₒᵣₑ, distribution. The SEM image shown in FIG. 5 (a) reveals that the MIL-125-NH₂ crystals have a morphology of the tetragonal plate, which was in good agreement with that reported by Hu et al. The average length and thickness were found to be ˜900 and ˜300 nm, respectively, of the current MIL-125-NH₂ particles. The FT-IR spectrum shown in FIG. 5 (b) confirms that the produced MIL-125-NH₂ particles had the typical vibrational bands in the region of 1400-1700 cm⁻¹ representing the carboxylic acid functional group of the Ti-coordinated MOF structure. Besides, the peaks in the region of 400-800 cm⁻¹ indicated the Ti—O—Ti vibrations, and the bands for NH₂ groups were present at 3500 and 3380 cm⁻¹. The band at 1250 cm⁻¹ indicated the symmetric C—H stretching vibrations in the benzene ring. All these stretch vibrations match well with that reported in the literature. The XRD pattern of the synthesized MOF particles (FIG. 5 (c)) is in an excellent agreement with the simulated pattern, demonstrating the successful formation of the MIL-125-NH₂ structure. FIG. 5 (d) shows the N₂ adsorption/desorption isotherms of the synthesized MIL-125-NH₂ particles. As expected, the MOF particles exhibited type I adsorption isotherms at 77 K with no hysteresis, which verifies their microporous nature. The pore diameter distribution was obtained by the DFT method and the results show that dominating pore diameter was about 0.75 nm. This were two types of cages (octahedral with 12.5 Å and tetrahedral with 6 Å) that are accessible through microporous windows (5-7 Å) were found for the MIL-125-NH₂. The surface area of MIL-125-NH₂ was calculated to be 1871 m² g⁻¹ using the multiple layer BET method (Table 3) which confirms the highly porous structure of the MIL-125-NH₂. The kinetic diameter of the toluene molecule is 5.85 Å (or 0.585 nm), which is expected to be easily captured by the MIL-125-NH₂ particles due to their high surface area and suitable pore diameter.

TABLE 3
BET analysis of pure MOF NPs, highly coated
E-MOFilters with different MOF NPs and two
activated carbon fiber (ACF) filters.

| | | BET | | |
|---|---|---|---|---|
| | MOF | surface | | Peak pore |
| | type and | area | Total/Micropore | diameter |
| | substrate | (m²/g) | volume (cm³/g) | (nm) |
| E-MOFilter | MIL-125-NH₂ | 320.6 | 0.149/0.114 | 0.79 |
| | (MERV 13) | | | |
| | MIL-125-NH₂ | 228.1 | 0.147/0.067 | 0.79 |
| | (HEPA) | | | |
| | ZIF-67 (HEPA) | 206.3 | 0.089/0.073 | 1.1 |
| | UIO-66-NH₂ | 175.1 | 0.092/0.062 | 0.72 |
| | (HEPA) | | | |
| Powder | MIL-125-NH₂ | 1871 | 0.837/0.667 | 0.75 |
| | ZIF-67 | 1346 | 0.920/0.796 | 1.1 |
| | UIO-66-NH₂ | 1231 | 0.681/0.432 | 0.70 |

| | | | |
|---|---|---|---|
| ACF-A | 369.3 | 0.170/0.134 | 1.2 |
| ACF-B | 213.4 | 0.159/0.020 | 1.2 |

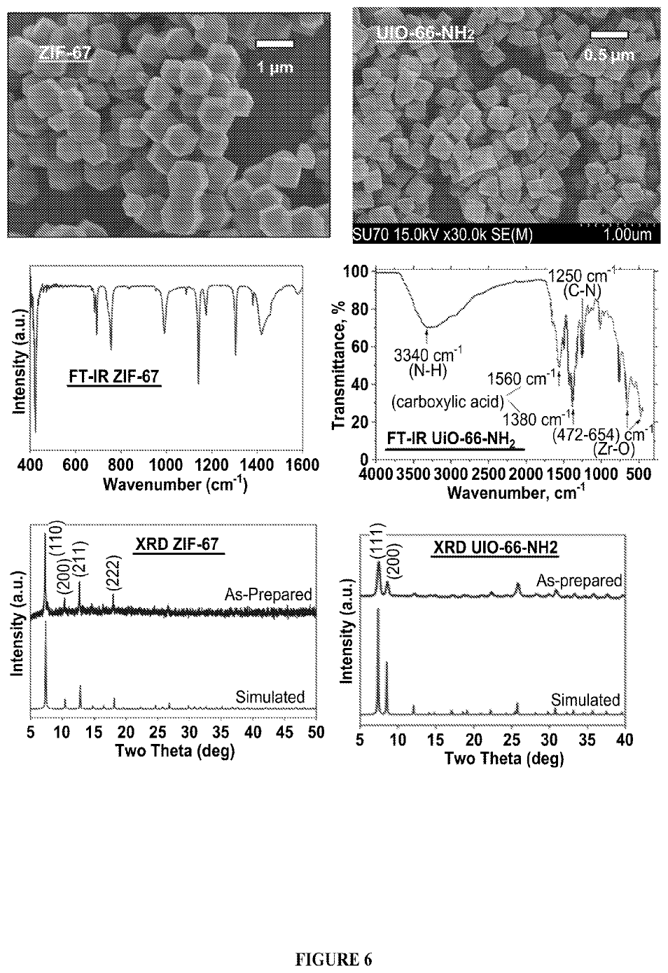

Theoretically, there are two main mechanisms for the adsorption of toluene molecules by the MIL-125-NH₂ particles. Firstly, it is the pore filling mechanism due to diffusion and the forces between the adsorbents and adsorbates are Van de Waal force as a result of dipole interactions, which can be assigned to physisorption process. The second one is due to the hydrogen bonding between the adsorbate (toluene) and adsorbent (MIL-125-NH₂), which can be assigned to the chemisorption process. According to the plausible pore filling adsorption mechanism, it is expected that the toluene molecules were easy to be trapped in the pore holes of MIL-125-NH₂ particles due to the matching sizes between the toluene and MIL-125-NH₂ particle cages. In the aspect of chemisorption, the hydrogen bonding between adsorbents and adsorbates that have ample H-donor moieties and H-acceptor moieties enhanced the capture of toluene. To be mentioned, to include ZIF-67 and UiO-66-NH₂ particles allows us to understand the effects of different pore diameters and ligands of different MOFs on toluene adsorption. The characterization results of ZIF-67 and UiO-66-NH₂ particles for SEM, FT-IR and XRD analysis (ZIF-67 only) were summerized in FIG. 6. The results confirm that the ZIF-67 and UiO-66-NH₂ particles were also successfully synthesized.

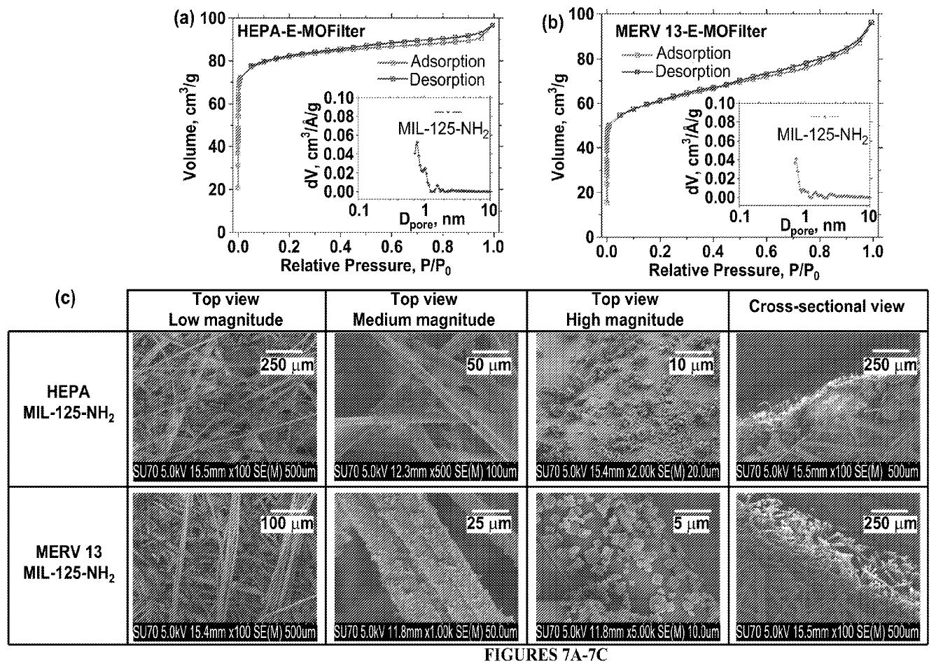

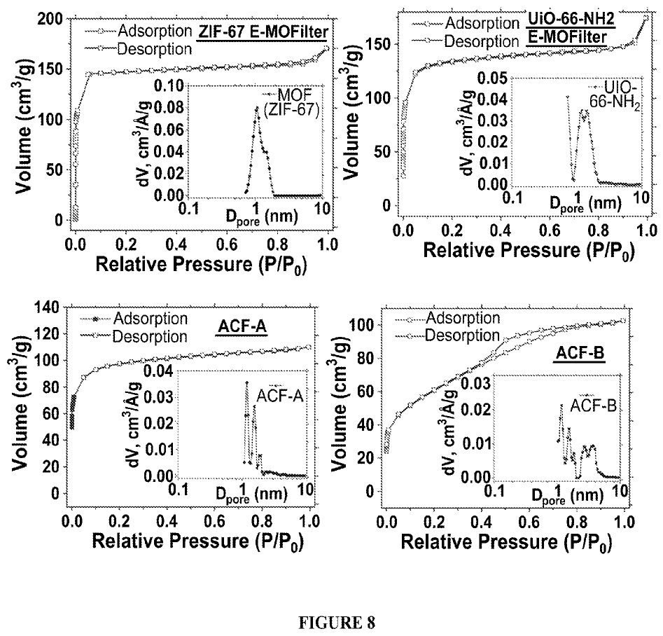

Characterization of different E-MOFilters: FIGS. 7 (a) and (b) show the pore size distribution for the HEPA and MERV 13 based E-MOFilters coated with MIL-125-NH₂ particles (25 wt %). The pore size distributions for the ZIF-67 and UiO-66-NH₂ coated HEPA E-MOFilters (25 wt %) are shown in FIG. 8. Table 3 summarizes the results of BET analysis, including surface area, pore volume, and peak pore diameter, for pure MOF particles, E-MOFilters coating with different MOF particle and two ACF filters for comparison (FIG. 8). It was found the peak pore sizes of all E-MOFilters were smaller than that of ACFs and the total surface areas of E-MOFilters were close to that of ACFs. It is expected the toluene removal efficiency between E-MOFilters and ACFs are comparable. The detailed discussion will be presented in the following. Compared with the MIL-125-NH₂ particles (FIG. 5d), the MIL-125-NH₂ coated E-MOFilters remained a similar peak pore diameter of ˜0.8 nm (Table 2). That is, the coated MIL-125-NH₂ particles contributed most of the microporous structures of the E-MOFilter, and a certain level of removal efficiency for toluene is expected. However, the pore volume for the pure MIL-125-NH₂ particles is much higher than that of E-MOFilters.

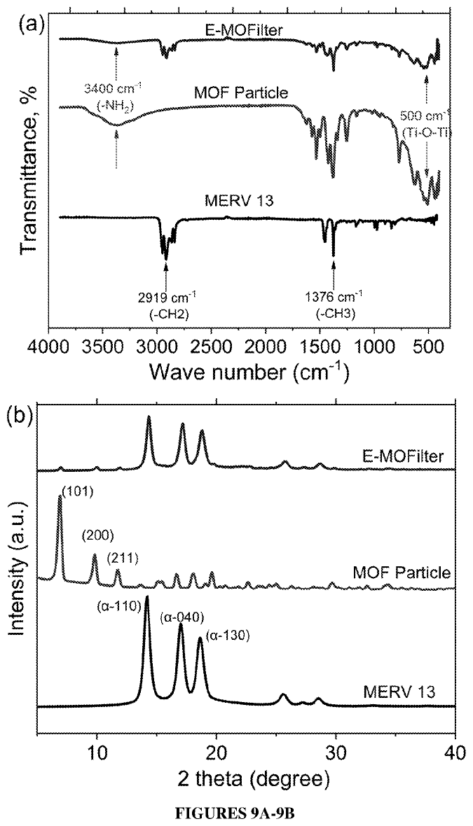

To examine if there are interactions between MOFs and electret media during coating, the FTIR and XRD characterization of the bare MERV 13 electret filter, MIL-125-NH₂ particles and MIL-125-NH₂ coated E-MOFilters was conducted. The comparison of the FTIR spectra and XRD patterns amongst MERV 13, MIL-125-NH₂ particles and E-MOFilter is shown in FIG. 9. As can be seen, the E-MOFilter remains both functional groups and crystal structures of MERV 13 media (polypropylene) and the MIL-125-NH₂ particles, a superposition from the two materials. It is concluded that the coating of MOFs onto the electret media by liquid filtration method was a physical phenomenon, i.e. no interaction caused between MOFs and electret media.

Under the high coating level of 25 wt %, FIG. 7 (c) shows the SEM images of the depositions for MIL-125-NH₂ particles in HEPA (first row) and MERV 13 (second row) based E-MOFilters. The cross-sectional views of the two E-MOFilters are shown in the last column of FIG. 7 (c). It is seen that the MOF particles were more uniformly deposited in MERV 13 based E-MOFilter, not only on individual fibers but also in depth (the cross-sectional view), than that of HEPA filter. In different magnitudes, from an overall view to the view with zoomed in of the filter media, it was found the smaller pore sizes and higher packing density (fine fiber part) of HEPA filters caused the occurrence of bridging and clogging in many portions of the filter, highlighted with circles, especially at interstitial spaces between fibers. Similar results were found for the low- and medium-level coated HEPA based E-MOFilter as the media pore to MOF particle size ratio dominated the coating uniformity. In the coating of ZIF-67 particles, as its average size is close to that of MIL-125-NH₂ particles (FIG. 6), a non-uniformity of coating is expected. However, the effects were minor when coating UiO-66-NH₂ particles to the HEPA media, which was due to their small sizes (˜250 nm, FIG. 6). Because of the small size of UiO-66-NH₂, this study found that they were not easy to be coated onto MERV 13 and a longer coating time is needed.

As will be shown later, the E-MOFilter coated with MIL-125-NH₂ particles had a better toluene removal efficiency than that of UiO-66-NH₂ and ZIF-67 particles, therefore, the results of MIL-125-NH₂ E-MOFilters will be focused and discussed in the following. To be concluded that from the coating experiments, without considering the adsorption ability amongst different MOFs, the ratio of the media pore size to MOF particle diameter is a crucial parameter determining if a uniform deposition can be achieved.

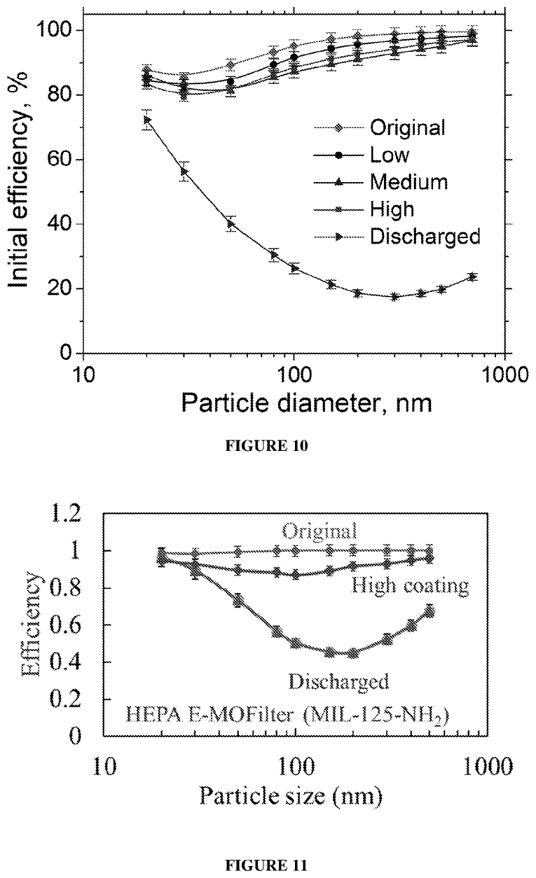

Initial efficiency of E-MOFilters (MIL-125-NH₂) for PMs: In order to investigate the effects of MOF coating on the performance of E-MOFilter against PMs, the size-fractioned efficiency of E-MOFilters was measured. FIG. 10 shows the results for the MIL-125-NH₂ coated MERV 13 (2 layers) E-MOFilters with different coating levels measured at 5 cm s⁻¹ face velocity. The original MERV 13 without MIL-125-NH₂particles and the discharged MERV 13 by isopropyl alcohol (IPA) vapor were also tested to determine the efficiency decline due to charge degradation and remainder from the coating. The decline of PM removal efficiency gets severer with increasing loading level due to charge shielding, nevertheless, the declines in all particle sizes were less than 10% for all three levels of coating. The E-MOFilter with a high-level MOF coating had a higher efficiency in the removal of larger particles than that with medium-level MOF coating, which should be attributed to loading effects. There were substantial efficiency differences between the E-MOFilters with that of discharged one, indicating a negligible efficiency degradation due to the coating. Although more MIL-125-NH₂ coating should enhance the capture of toluene, to compromise the decay of PM efficiency and the increase of pressure drop, and the decline of PM holding capacity (shown later), low or medium level of coating might be more desirable. A similar result with only minor efficiency decline was obtained for the HEPA E-MOFilters coated with high level of MIL-125-NH₂ (FIG. 11).

One question that may be asked is if the shedding of MOF particles can occur during the filtration of E-MOFilters. To address this issue, the MERV 13 E-MOFilters coated with all three levels of MIL-125-NH₂ were tested. In the experiments, E-MOFilters were blown with clean air at face velocities of 5 and 10 cm s⁻¹, the common filtration velocities, and a raised velocity of 30 cm s⁻¹ for challenging the stability of the current coating method. The air downstream of the filter was introduced to the UCPC which was operated with the accumulation counting mode. Ten times with one minute for each was run. Table 4 shows the results of the particle shedding, in which the average values and standard deviations were rounded to the nearest integer. Shedding of particles does increase with increasing velocity and coating level. However, a quick calculation shows that there will be only ˜0.001-0.01% of MOF particles released for the high coating E-MOFilter being operated at 30 cm s⁻¹ for 7/24 for a year. Therefore, the coating method presented here maintains the merits of electret media, including high efficiency and low pressure drop, and has a negligible shedding effect.

TABLE 4
Shedding test for MERV 13 E-MOFilter, count/min.

| count/min | MOFilter coating level | | |
|---|---|---|---|
| Face velocity | Low | Medium | High |
| 5 cm/s | 0 | 1 ± 0 | 3 ± 0 |
| 10 cm/s | 1 ± 0 | 10 ± 1 | 11 ± 1 |
| 30 cm/s | 5 ± 1 | 13 ± 1 | 17 ± 1 |

Performance of E-MOFilters on PM loading: For an IAC or HVAC filter, in addition to the initial efficiency, its performance over a period of operation, e.g., a few months, is of great concern. A commonly applied criterion is the PM holding capacity, i.e., the loaded PM mass versus the pressure drop growth which relates to the energy consumption in operating the filtration. Besides, as an electret media, its efficiency usually declines from the beginning of the operation, due to charge shielding, until loading effects occur and beat the decline. Therefore, this time-dependent and dynamic filter efficiency should also be considered as the second criterion. Since the focus of this study was to examine if the coating of MOF particles could deteriorate the performance of the electret media, only the two criteria about PM loading will be compared, as follows. The insights into PM loading characteristics for electret media, i.e., mechanisms of charge decay, transitions in the pressure drop growth curve, loading effects on efficiency enhancement, etc., can be ascertained.

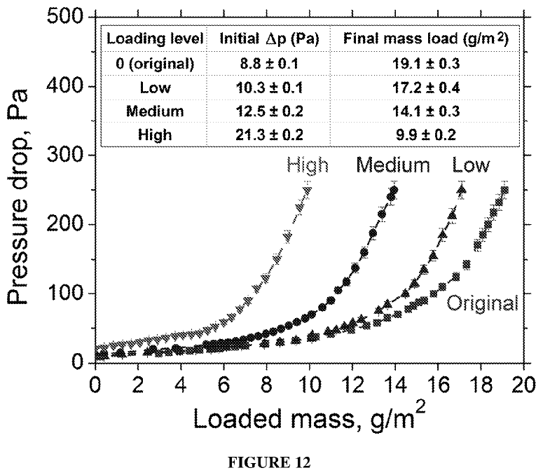

FIG. 12 compares the PM_{2.5} holding capacities of the clean MERV 13 and MERV 13 E-MOFilters coated with different levels of MIL-125-NH₂ particles. The initial pressure drop of these filters are also shown in the figure and it was found the increase of initial pressure drops were very minor with only 1.5 and 3.7 Pa for the low and medium coated E-MOFilters, respectively. In comparison, the highly coated E-MOFilter gained a significant pressure drop (12.5 Pa). In the PM_{2.5} aging tests, the endpoint was set at 1.0 in-H₂O (249 Pa) and the more mass of PMs can be collected the better the filter is. As expected, the clean MERV 13 had the highest holding capacity (19.1 g m⁻²) and it was about 10, 25, and 50% higher than that of the low, medium, and high coating, respectively. It becomes clear that, in terms of deterioration of PM holding capacity, the E-MOFilters with low and medium coating should be acceptable, whereas, not for the high coating.

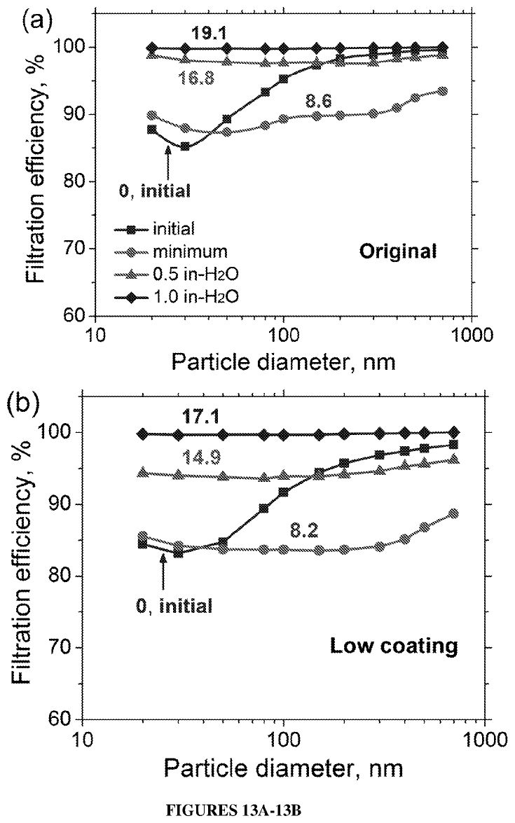

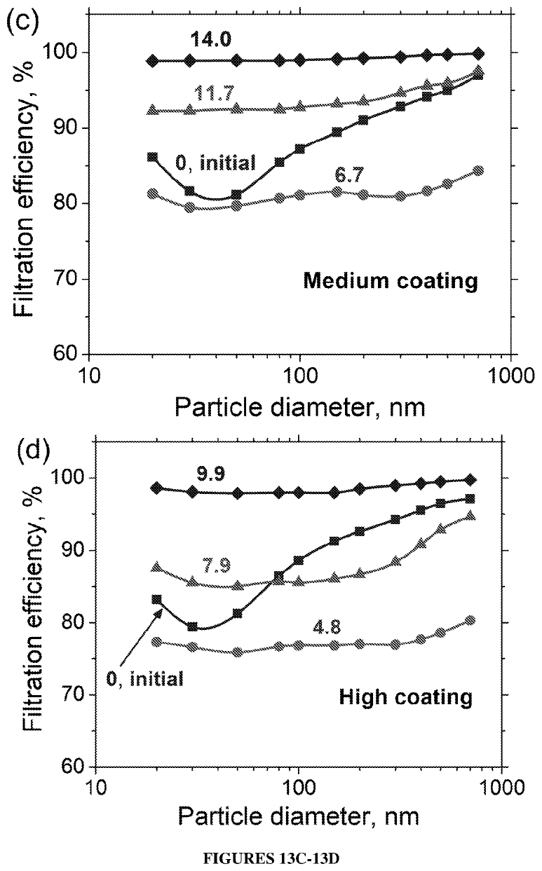

FIG. 13 compares dynamic size-fractioned efficiency at different mass loads amongst original MERV 13 and E-MOFilters with the three coating levels (MIL-125-NH₂). The curves in each figure correspond to the efficiencies at initial (0 loading), minimum values (onset of efficiency increase for most particle sizes), pressure drop at 0.5 in-H₂O, and 1.0 in-H₂O (endpoint of aging), respectively. The minimum efficiency is important as it represents the worst filtration condition in the use of electret-based filters. When the loading started, due to charge degradation the size-fractioned efficiency of these electret filters began declining (except for small particles in original and low coating level media) from their initial efficiency to the minimum efficiency, after which filter efficiency kept increasing because of loading effects.

The minimum efficiencies of low and medium coated E-MOFilters remain to be greater than 80%, whereas the minimum efficiency for the one with high MOF coating was found to be less than 80%. To be highlighted, the small particles (<50 nm) did not or almost had no efficiency reduction during the PM loading. This was because their deposition mechanism inherently relied mainly on diffusion rather than electrostatic force. From FIG. 13, it is seen the dynamic efficiency curves of E-MOFilters did differ quite much from the original MERV 13, nevertheless, the trend remained a very close characteristic as the original MERV 13. In summary, the test results for PM loading for E-MOFilters confirmed the current coating method, liquid filtration and from back to front, did not degrade the fiber charge too much or alter the fiber structure of electret media.

Performance of E-MOFilters for Toluene Removal

Initial removal efficiency: In the previous section, the performances of E-MOFilters for PM removal have been demonstrated to be comparable to that of the original electret filters, especially for the E-MOFilters with low and medium level coating. In this section, the removal of toluene by the E-MOFilters will be quantitatively compared amongst different base substrates, MERV 13 (1 or 2 layers) and HEPA, and different MOF particles and different levels of coating.

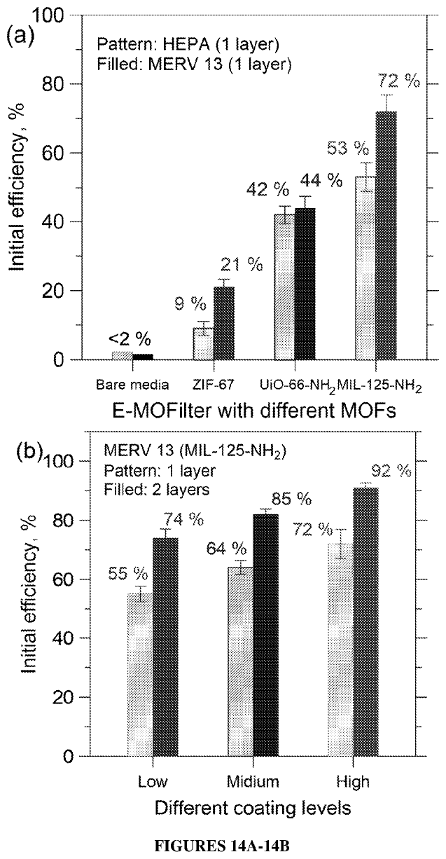

FIG. 14 (a) compares the initial toluene removal efficiency under 5 cm s⁻¹ face velocity between the MERV 13 (1 layer) and HEPA (1 layer) E-MOFilters coated with high levels (25 wt %) of the three MOF particles. The removal efficiency by the bare electret filter is also included, and it was found to be less than 2% for both HEPA and MERV 13 media, indicating the toluene removal was mainly attributed to the MOF particles. An order of MIL-125-NH₂>UiO-66-NH₂>ZIF-67 for the toluene removal efficiency was found for both MERV 13 and HEPA E-MOFilters. In comparison, the MERV 13 exhibited better performance than HEPA towards the toluene removal when coated with MOF particles. This was attributed to the uniformity of coating influenced by the ratio of media pore to MOF particle diameter as discussed herein. The ZIF-67 (29% with MERV 13) and UiO-66-NH₂ (44% with MERV 13) may not be qualified to be applied in the E-MOFilter as their efficiencies were too low. While for MIL-125-NH₂, the efficiency was as good as 72%. This promising result should be highlighted because the method proposed within this study does prove not only the coating method retains the charge of electret media but also the coated MOF particles can remove toluene efficiently. From the above discussion, the HEPA, ZIF-67, and UiO-66-NH₂ could be excluded from the further tests in examining the effects of the coating level and using two layers of MERV 13 on toluene removal efficiency and adsorption capacity.

FIG. 14 (b) compares the toluene removal efficiency amongst 1 and 2 layers of MERV 13 E-MOFilters coated with three levels of MIL-125-NH₂ under 5 cm s⁻¹ face velocity. Reasonably, the efficiency increases with one additional layer of MERV 13 and coating level of MOF particles, however, not as large as expected. An average improvement of ˜20% from 1 layer to 2 layers and ˜8% from increasing coating level was obtained. To be mentioned, the 2-layer low coated E-MOFilter already had a decent efficiency of 74%. Besides, 2 layers of MERV 13 is required as it would enhance the PM removal efficiency and toluene adsorption capacity which will be shown later.

From the results of the initial toluene removal efficiency shown in FIG. 14, it becomes clear that the ratio of the filter pore size to MOF particle size is a crucial parameter for achieving a good coating and thus a good toluene removal. Besides, the amino functional group in ligand should also contribute to the toluene removal via chemisorption. Although HEPA filter has high initial efficiency, however, electret HEPA filter has a much lower holding capacity for PM, therefore, applying MERV 13 (two layers here) as the coating substrate is more desirable. Its larger pore size increases the flexibility to be the base substrate for coating many other MOF particles with different sizes, which may extend the applications for removing other gaseous pollutants.

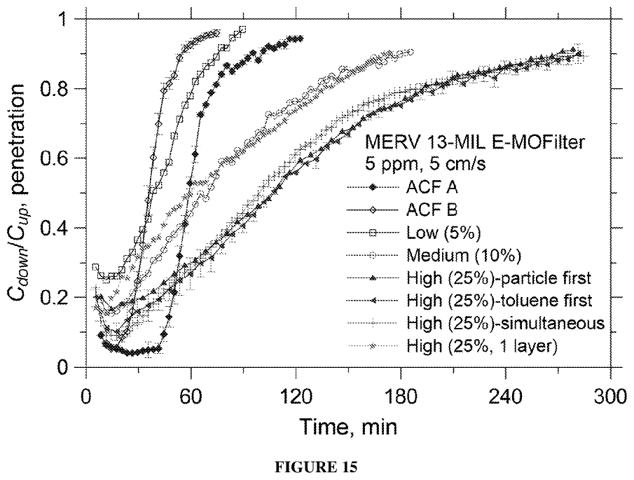

Toluene adsorption capacity: FIG. 15 shows the toluene adsorption capacity, or breakthrough curve, of the 2-layer MERV 13 E-MOFilter coated with different levels of MIL-125-NH₂. The breakthrough curve for 2 ACF filters used in respirators for welding workers and the 1-layer E-MOFilter with high coating are also shown for comparison. It can be seen that the adsorption capacity increases substantially with increasing coating quantity. The two ACFs do have higher initial efficiency, ˜90-95%, however, their adsorption capacity is only comparable with the low coating E-MOFilter, and worse than the medium and high coating E-MOFilters. The capacity of the 1-layer highly coated E-MOFilter is close to that of medium coated 2-layer E-MOFilter but lower than the 2-layer highly coated one, indicating the doubling of MOF particles does increase the toluene adsorption capacity. A rough calculation considering the area of the right triangle upper the breakthrough curve shows the captured quantity of toluene is about double by the 2-layer E-MOFilter.

FIG. 15 also compares the adsorption capacity amongst the E-MOFilters evaluated for PM loading first (particle first), toluene adsorption first (toluene first), and simultaneously but without characterizing PM efficiency and loading (simultaneous) to understand whether the treatment order and separate measurement would lead to different results. Results showed that the adsorption capacity for treating toluene first was only slightly better than that of particle first and the simultaneous one, the current results of E-MOFilters for different coating levels and different MOFs are applicable for the real operation when particle and toluene filtrations are taking place simultaneously. Based on the decent results obtained, the newly developed method for the fabrication of E-MOFilter should be extended to the applications in making filter media for IAC, HVAC, and respirator filters. Although the 2-layer highly coated E-MOFilter had an outstanding performance towards the removal of toluene, an overall evaluation on the trade-off of gained pressure drop and charge degradation causing the decline of PM initial efficiency and PM holding capacity is needed. Both low and medium coated 2-layer MOFilter would be good choices for now before an optimized coating condition and better MOF particles are found.

Conclusion

Three MOF particles, including MIL-125-NH₂, UiO-66-NH₂ and ZIF 67, were synthesized, characterized, and coated to a MERV 13 and a HEPA grade electret filter media to form E-MOFilters for the simultaneous removal of fine particulate matters (PM_{2.5}) and volatile organic compounds (VOCs). As for the MOF coating, 5, 10 and 25 wt % of the mass of the MERV 13 and HEPA media were applied to figure out which level is the most appropriate, in terms of low increase of air resistance, low charge degradation, and sufficient VOC removal efficiency and adsorption capacity. A series of measurements were conducted to test the initial efficiency and holding/adsorption capacity of PM and toluene by the E-MOFilters.

The characterization results show that the MOF particles were successfully synthesized with similar morphology, size, surface area, pore diameter, FT-IR spectrum, and XRD patterns to those reported in the literature. The PM removal performances, in terms of initial efficiency, holding capacity, and dynamic efficiency, of the low and medium coated E-MOFilter were found to be comparable to the original MERV 13. However, the highly coated one gained an essential air resistance and had a much lower PM holding capacity. The comparison of the time-dependent size-fractioned efficiency along the aging between E-MOFilter and original electret media shows that they have a similar trend of efficiency decline due to charge shielding and efficiency enhancement caused by loading effects. This indicates the coating method presented here does not significantly deteriorate the charge density and change the fibrous structure to a considerable extent.

The initial toluene removal efficiency of the MERV 13 E-MOFilters coated with MIL-125-NH₂ reaches 74% and 85% for the low and medium coating levels, respectively. It was found the pore of filter media to MOF particle size is a crucial parameter for achieving a good coating and good toluene removal. Although HEPA filter had high initial efficiency, its lower holding capacity for PM and small pore size result in clogging during the MOF coating. Therefore, using MERV 13 as the coating substrate is more desirable. From the toluene adsorption capacity results, it is seen the newly developed MERV 13 E-MOFilter had a comparable capacity to that of two ACF media used in the respirators for welding workers. The low medium and high coating MOFilter predominated the ACFs. However, to consider the deterioration of the PM removal for the highly coated E-MOFilter, the parameters of the low and medium coated E-MOFilter may be more desirable to be applied in the designs of IAC, HVAC, and respirator filters.

1. An electret-MOF filter comprising:
a) a charged polymeric fibrous web; and
b) metal-organic framework (MOF) particles dispersed throughout the charged polymeric fibrous web, wherein the MOF particles comprise pores and have a surface area of at least 500 m² g⁻¹.

2. The electret-MOF filter of claim 1, wherein the MOF particles comprise pores and have a pore volume of at least 0.3 cm³/g.

3. The electret-MOF filter of claim 1, wherein the MOF particles are microporous (exhibiting a type I adsorption isotherms at 77 K with no hysteresis), mesoporous, or a combination thereof.

4. The electret-MOF filter of claim 1, wherein the MOF particles are microporous having an average pore size of less than 2 nm.

5. (canceled)

6. (canceled)

7. (canceled)

8. The electret-MOF filter of claim 1, wherein the MOF particles are selected from MIL-125-NH₂, UiO-66-NH₂ or ZIF-67.

9. The electret-MOF filter of claim 1, wherein the MOF particles have a longest dimension of 3 microns or less.

10. The electret-MOF filter of claim 1, wherein the MOF particles are chemically or physically functionalized for tuning their binding selectivity, improving coating uniformity, reducing relative humidity (RH) effects on toluene efficiency reduction, improving hydrophobic or hydrophilic stability, or a combination thereof.

11. The electret-MOF filter of claim 1, wherein the MOF particles are stable in hydrophilic or hydrophobic environments.

12. (canceled)

13. The electret-MOF filter of claim 1, wherein the charged polymeric fibrous web is a charged non-woven microfiber web.

14. The electret-MOF filter of claim 1, wherein the charged polymeric fibrous web comprises fibers having an average fiber diameter of 100 microns or less.

15. The electret-MOF filter of claim 1, comprising two or more layers of charged polymeric fibrous webs, wherein a first layer comprises a first fiber having an average fiber diameter of 20 microns or less, and wherein a second layer comprises a second fiber having an average fiber diameter of 20 microns or greater.

16. The electret-MOF filter of claim 1, comprising one or more layers of the charged polymeric fibrous web, each layer having an average thickness of 2 mm or less.

17. The electret-MOF filter of claim 1, wherein the charged polymeric fibrous web has a total average thickness of 20 mm or less.

18. The electret-MOF filter of claim 1, wherein the charged polymeric fibrous web has a basis weight of 150 g/m² or less.

19. The electret-MOF filter of claim 1, wherein the MOF particles are present in an amount of up to 30% by weight of the electret-MOF filter.

20. The electret-MOF filter of claim 1, wherein the ratio of pore size of the electret-MOF filter to the diameter of the MOF particles is 30 or less.

21. The electret-MOF filter of claim 1, wherein the electret-MOF filter exhibits:
a volatile organic compound (VOC) load reduction of at least 75%, when tested at a VOC concentration of 5 ppm with 5 cm s⁻¹ face velocity;
a PM_{2.5} load reduction of at least 80% in mass, when tested under 5 cm s⁻¹ face velocity;
or a combination thereof.

22. (canceled)

23. The electret-MOF filter of claim 1, wherein
the electret-MOF filter exhibits a charge retention of at least 95%, tested using a water soaking-drying tests;
the electret-MOF filter exhibits a pressure drop of less than 50 Pa, tested at 5 cm/s (Pa);
or a combination thereof.

24. (canceled)

25. A device comprising the electret-MOF filter of claim 1, wherein the device is a respirator filter, a room or building ventilation system filter, a vehicle, train, bus and airplane ventilation system filter, an air conditioner filter, a furnace filter, a room air purifier filter, a vacuum cleaner filter, or a computer disk drive filter.

26. A process for simultaneously adsorbing particulate and volatile organic compounds in a gaseous environment, the process comprising contacting the environment with the electret-MOF filter according to claim 1.

27. (canceled)

28. (canceled)

29. A method of preparing the electret-MOF filter of claim 1, the method comprising:
a) suspending MOF particles in a solvent at a concentration of 1.0 wt % or less to form a MOF particle mixture,
b) contacting a charged polymeric fibrous web with the MOF particle mixture, and
c) coating the charged polymeric fibrous web with the MOF particles by flowing the MOF particle mixture through an inverse side of the charged polymeric fibrous web at a flow rate of at least 10 mL·min⁻¹.

30. (canceled)
